(19) United States
(12) Patent Application Publication
(10) Pub. No.: US 2013/0027440 A1
(43) Pub. Date: Jan. 31, 2013

(54) ENHANCED GRAYSCALE METHOD FOR FIELD-SEQUENTIAL COLOR ARCHITECTURE OF REFLECTIVE DISPLAYS

(71) Applicants: Russel Allyn Martin, Menlo Park, CA (US); Zhanpeng Feng, Fremont, CA (US); Jyotindra Raj Shakya, Sunnyvale, CA (US); Paul Eric Jacobs, La Jolla, CA (US); Clarence Chui, San Jose, CA (US)

(72) Inventors: Russel Allyn Martin, Menlo Park, CA (US); Zhanpeng Feng, Fremont, CA (US); Jyotindra Raj Shakya, Sunnyvale, CA (US); Paul Eric Jacobs, La Jolla, CA (US); Clarence Chui, San Jose, CA (US)

(73) Assignee: QUALCOMM MEMS TECHNOLOGIES, INC., San Diego, CA (US)

(21) Appl. No.: 13/539,016

(22) Filed: Jun. 29, 2012

Related U.S. Application Data
(60) Provisional application No. 61/511,180, filed on Jul. 25, 2011.

(51) Int. Cl. G09G 5/10

(52) U.S. Cl. 345/690

(57) ABSTRACT

A field-sequential color architecture is included in a reflective mode display. The reflective mode display may be a direct-view display such as an interferometric modulator display. The reflective mode display may include three or more different subpixel types, each of which corresponds to a color. Data for each color may be written sequentially to all subpixels of the display. Flashing of a corresponding colored light, e.g., from a front light of the display, may be timed to immediately follow a process of writing data for that color. Colors other than the field color may be used to produce grayscale. The field color may correspond to the most significant bit (MSB) and the other colors may correspond to other bits.

### PRIORITY CLAIMS

This application claims priority to U.S. Provisional Patent Application No. 61/511,180, filed on Jul. 25, 2011 and entitled “FIELD-SEQUENTIAL COLOR ARCHITECTURE OF REFLECTIVE MODE MODULATOR” (Attorney Docket QUALP086P/112216P1), which is hereby incorporated by reference in its entirety and for all purposes.

### TECHNICAL FIELD

This disclosure relates to display devices, including but not limited to display devices that incorporate electromechanical systems.

### DESCRIPTION OF THE RELATED TECHNOLOGY

Electromechanical systems include devices having electrical and mechanical elements, actuators, transducers, sensors, optical components (e.g., mirrors) and electronics. Electromechanical systems can be manufactured at a variety of scales including, but not limited to, microscales and nanoscales. For example, microelectromechanical systems (MEMS) devices can include structures having sizes ranging from about a micron to hundreds of microns or more. Nanoelectromechanical systems (NEMS) devices can include structures having sizes smaller than a micron including, for example, sizes smaller than several hundred nanometers. Electromechanical elements may be created using deposition, etching, lithography, and/or other micromachining processes that etch away parts of substrates and/or deposited material layers, or that add layers to form electrical and electromechanical devices.

One type of electromechanical systems device is called an interferometric modulator (IMOD). As used herein, the term interferometric modulator or interferometric light modulator refers to a device that selectively absorbs and/or reflects light using the principles of optical interference. In some implementations, an interferometric modulator may include a pair of conductive plates, one or both of which may be transparent and/or reflective, wholly or in part, and capable of relative motion upon application of an appropriate electrical signal. In an implementation, one plate may include a stationary layer deposited on a substrate and the other plate may include a reflective membrane separated from the stationary layer by an air gap. The position of one plate in relation to another can change the optical interference of light incident on the interferometric modulator. Interferometric modulator devices have a wide range of applications, and are anticipated to be used in improving existing products and creating new products, especially those with display capabilities.

The color gamut of a conventional reflective mode display, such as an IMOD display, is normally less saturated in low ambient light conditions than other types of displays, such as liquid crystal displays (LCDs). To allow viewing in darker environment, a front light (e.g., formed of light-emitting diodes (LEDs)) may be provided with a conventional reflective mode display to supplement weak ambient lighting. Currently, for a color IMOD display, a front light may be turned on to shine white light onto the IMOD display while rows of the IMOD display are being scanned and color data are being written. However, such color displays are still less saturated, and are susceptible to color shifts when the viewing angle is changed.

### SUMMARY

The systems, methods and devices of the disclosure each have several innovative aspects, no single one of which is solely responsible for the desirable attributes disclosed herein.

One innovative aspect of the subject matter described in this disclosure can be implemented in an apparatus in which a field-sequential color architecture is included in a reflective mode display. The reflective mode display may be a direct-view display such as an IMOD display. In some implementations, the reflective mode display may include three or more different subpixel types, each of which corresponds to a color. In some such implementations, the colors include primary colors. Data for each color may be written sequentially to all subpixels of the display. Flashing of a corresponding colored light, e.g., from a front light of the display, may be timed to immediately follow a process of writing data for that color.

Some implementations described herein use colors other than the primary field color to produce grayscale. In one three-bit example, the primary field color may correspond to the most significant bit (MSB) and the other colors may correspond to the other two bits. For the red field, the red subpixel may be driven according to the MSB, the green subpixel may be driven according to the next bit and the blue subpixel may be driven according to the least significant bit (LSB). In this manner, eight different brightness levels may be obtained for each field color. Although the state of each reflective subpixel corresponds with a bit in this example, the contributions of each subpixel will not generally correspond with powers of two. Other implementations may involve more or fewer bits and brightness levels.

Another innovative aspect of the subject matter described in this disclosure can be implemented in a reflective display that includes a front light, a plurality of first reflective sub-pixels corresponding to a first color, a plurality of second reflective sub-pixels corresponding to a second color, a plurality of third reflective sub-pixels corresponding to a third color and a control system. The control system may be configured to write a most significant bit (MSB) of first data corresponding to the first color to at least some of the first reflective sub-pixels, to write a least significant bit (LSB) of the first data to at least some of the third reflective sub-pixels and to control the front light to flash the first color on the reflective display after the first data have been written to the first, second and third reflective sub-pixels. The control system may be further configured to write a next bit or a least significant bit (LSB) of the first data to at least some of the second reflective sub-pixels.

The control system may be further configured to write an MSB of second data corresponding to the second color to at least some of the second reflective sub-pixels, to write an LSB of the second data to at least some of the third reflective sub-pixels and to control the front light to flash the second color on the reflective display after the second data have been written to the second and third reflective sub-pixels. The control system may be further configured to write a next bit or a least significant bit (LSB) of the second data to at least some of the first reflective sub-pixels.

The control system may be further configured to write an MSB of third data corresponding to the third color to at least some of the third reflective sub-pixels, to write an LSB of the third data to at least some of the first reflective sub-pixels and to control the front light to flash the third color on the reflective display after the third data have been written to the first and third reflective sub-pixels. The control system may be further configured to write a next bit or a least significant bit (LSB) of the third data to at least some of the second reflective sub-pixels.

The control system may include at least one of a general purpose single-chip or multi-chip processor, a digital signal processor (DSP), an application specific integrated circuit (ASIC), a field programmable gate array (FPGA) or other programmable logic device, discrete gate or transistor logic, or discrete hardware components. The control system may be further configured to assign bit values according to grayscale levels that correspond with values of the MSB, the next bit and the LSB. The control system may be further configured to receive grayscale level data and to determine the bit values according to the grayscale level data. The control system may be further configured to determine the bit values by referencing a data structure that has the grayscale levels and corresponding values of the MSB, the next bit and the LSB stored therein.

In some implementations, the first reflective sub-pixels may have a first spectral response with a first peak wavelength range corresponding to the first color, the second reflective sub-pixels may have a second spectral response with a second peak wavelength range corresponding to the second color and the third reflective sub-pixels may have a third spectral response with a third peak wavelength range corresponding to the third color. The second spectral response may overlap with the first spectral response within the first peak wavelength range and may overlap with the third spectral response within the third peak wavelength range.

The next bit of the first data may correspond with the second spectral response of the second reflective sub-pixels within the first peak wavelength range. The next bit of the third data may correspond with the second spectral response of the second reflective sub-pixels within the third peak wavelength range.

The MSB of the first data may correspond with the first spectral response of the first reflective sub-pixels within the first peak wavelength range. The MSB of the second data may correspond with the second spectral response of the second reflective sub-pixels within the second peak wavelength range. The MSB of the third data may correspond with the third spectral response of the third reflective sub-pixels within the third peak wavelength range.

The first spectral response may overlap with the third spectral response within the third peak wavelength range. The third spectral response may overlap with the first spectral response within the first peak wavelength range.

The LSB of the first data may correspond with the third spectral response of the third reflective sub-pixels within the first peak wavelength range. The LSB of the second data corresponds with the third spectral response of the third reflective sub-pixels within the second peak wavelength range. The LSB of the third data may correspond with the first spectral response of the first reflective sub-pixels within the third peak wavelength range.

The reflective display may include a memory device. The control system may include a processor that is configured to process image data and is configured to communicate with the reflective display and the memory device. The control system may include a driver circuit configured to send at least one signal to the display and a controller configured to send at least a portion of the image data to the driver circuit. The reflective display may include an image source module configured to send the image data to the processor. The image source module may include a receiver, a transceiver and/or a transmitter. The reflective display may include an input device configured to receive input data and to communicate the input data to the control system.

Another innovative aspect of the subject matter described in this disclosure can be implemented in a method of controlling a reflective display. The method may involve writing an MSB of first data corresponding to a first color to first reflective sub-pixels, writing an LSB of the first data to third reflective sub-pixels corresponding to a third color and controlling a front light to flash the first color on the reflective display after the first data have been written to the first and third reflective sub-pixels. The method may involve writing a next bit or an LSB of the first data to second reflective sub-pixels corresponding to a second color.

The method may involve writing an MSB of second data corresponding to the second color to the second reflective sub-pixels, writing an LSB of the second data to the third reflective sub-pixels and controlling the front light to flash the second color on the reflective display after the second data have been written to the second and third reflective sub-pixels. The method may involve writing a next bit or an LSB of the second data to the first reflective sub-pixels.

The method may involve writing an MSB of third data corresponding to the third color to the third reflective sub-pixels, writing an LSB of the third data to the first reflective sub-pixels and controlling the front light to flash the third color on the reflective display after the third data have been written to the first and third reflective sub-pixels. The method may involve writing a next bit or an LSB of the third data to the second reflective sub-pixels.

Another innovative aspect of the subject matter described in this disclosure can be implemented in a non-transitory storage medium having software encoded thereon. The software may include instructions for controlling a reflective display to perform a method that involves writing an MSB of first data corresponding to a first color to first reflective sub-pixels corresponding to the first color, writing an LSB of the first data to second reflective sub-pixels corresponding to a second color, writing the LSB of the first data to third reflective sub-pixels corresponding to a third color and controlling a front light to flash the first color on the reflective display after the first data have been written to the first, second and third reflective sub-pixels.

The method may involve writing an MSB of second data corresponding to the second color to the second reflective sub-pixels, writing an LSB of the second data to the first reflective sub-pixels, writing the LSB of the second data to the third reflective sub-pixels and controlling the front light to flash the second color on the reflective display after the second data have been written to the first, second and third reflective sub-pixels.

The method may involve writing an MSB of third data corresponding to the third color to the third reflective sub-pixels, writing an LSB of the third data to the second reflective sub-pixels, writing the LSB of the third data to the first reflective sub-pixels and controlling the front light to flash the third color on the reflective display after the third data have been written to the first, second and third reflective sub-pixels.

Details of one or more implementations of the subject matter described in this specification are set forth in the accompanying drawings and the description below. Although the examples provided in this summary are primarily described in terms of MEMS-based displays, the concepts provided herein may apply to other types of reflective displays, such as cholesteric LCD displays, transflective LCD displays, electrofluidic displays, electrophoretic displays and displays based on electro-wetting technology. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of an isometric view depicting two adjacent pixels in a series of pixels of an interferometric modulator (IMOD) display device.

FIG. 2 shows an example of a system block diagram illustrating an electronic device incorporating a 3×3 interferometric modulator display.

FIG. 3 shows an example of a diagram illustrating movable reflective layer position versus applied voltage for the interferometric modulator of FIG. 1.

FIG. 4 shows an example of a table illustrating various states of an interferometric modulator when various common and segment voltages are applied.

FIG. 5A shows an example of a diagram illustrating a frame of display data in the 3×3 interferometric modulator display of FIG. 2.

FIG. 5B shows an example of a timing diagram for common and segment signals that may be used to write the frame of display data illustrated in FIG. 5A.

FIG. 6A shows an example of a partial cross-section of the interferometric modulator display of FIG. 1.

FIGS. 6B-6E show examples of cross-sections of varying implementations of interferometric modulators.

FIG. 7 shows an example of a flow diagram illustrating a manufacturing process for an interferometric modulator.

FIGS. 8A-8E show examples of cross-sectional schematic illustrations of various stages in a method of making an interferometric modulator.

FIG. 9 shows an example of a flow diagram outlining processes of some methods described herein.

FIG. 10A shows an example of a diagram that depicts how components of a reflective display may be controlled according to a method outlined in FIG. 9.

FIG. 10B shows an example of a diagram that depicts how components of a reflective display may be controlled according to an alternative method outlined in FIG. 9.

FIG. 11 shows an example of a flow diagram outlining processes of alternative methods described herein.

FIG. 12 shows an example of a diagram that depicts how components of a reflective display may be controlled according to a method outlined in FIG. 11.

FIG. 13 shows an example of a graph of the spectral response of three interferometric modulation subpixels, each of which corresponds to a different color.

FIG. 14 shows an example of a flow diagram outlining processes for alternating between driving odd and even rows of interferometric modulators in a display.

FIG. 15A shows an example of rows of interferometric modulators in a display.

FIG. 15B shows an example of a diagram that depicts how to alternate between driving odd and even rows of interferometric modulators in a display without driving rows to black.

FIG. 16 shows an example of a flow diagram outlining processes for simultaneously writing more than one color to rows of interferometric modulators in a display.

FIG. 17 shows an example of a flow diagram outlining processes for sequentially writing data for a single color to all interferometric modulators in a display.

FIG. 18 shows an example of a graph of color gamut versus brightness of ambient light for different types of displays.

FIG. 19 shows an example of a flow diagram outlining processes for controlling a display according to the brightness of ambient light.

FIG. 20 shows an example of a graph of data that may be referenced in a process such as that outlined in FIG. 19.

FIG. 21 shows an example of a graph of the spectral response of a green interferometric subpixel being illuminated by a magenta light.

FIG. 22 shows an example of a graph of the spectral response of three reflective subpixels, each of which has an intensity peak that corresponds to a different color.

FIG. 23 shows an example of reflective subpixel configurations corresponding to three bits and eight grayscale levels.

FIG. 24 shows an example of a flow diagram outlining a process for controlling a reflective display according to a grayscale method for field-sequential color.

FIG. 25 shows an example of controlling subpixels of a reflective display according to the process of FIG. 24.

FIG. 26 shows an example of reflective subpixel configurations corresponding to two bits and four grayscale levels.

FIG. 27 shows an example of a flow diagram outlining an alternative process for controlling a reflective display according to a grayscale method for field-sequential color.

FIGS. 28A and 28B show examples of system block diagrams illustrating a display device that includes a plurality of interferometric modulators.

Like reference numbers and designations in the various drawings indicate like elements.

### DETAILED DESCRIPTION

The following detailed description is directed to certain implementations for the purposes of describing the innovative aspects. However, the teachings herein can be applied in a multitude of different ways. The described implementations may be implemented in any device that is configured to display an image, whether in motion (e.g., video) or stationary (e.g., still image), and whether textual, graphical or pictorial. More particularly, it is contemplated that the implementations may be implemented in or associated with a variety of electronic devices such as, but not limited to, mobile telephones, multimedia Internet enabled cellular telephones, mobile television receivers, wireless devices, smartphones, bluetooth devices, personal data assistants (PDAs), wireless electronic mail receivers, hand-held or portable computers, netbooks, notebooks, smartbooks, printers, copiers, scanners, facsimile devices, GPS receivers/navigators, cameras, MP3 players, camcorders, game consoles, wrist watches, clocks, calculators, television monitors, flat panel displays, electronic reading devices (e.g., e-readers), computer monitors, auto displays (e.g., odometer display, etc.), cockpit controls and/or displays, camera view displays (e.g., display of a rear view camera in a vehicle), electronic photographs, electronic billboards or signs, projectors, architectural structures, microwaves, refrigerators, stereo systems, cassette recorders or players, DVD players, CD players, VCRs, radios, portable memory chips, washers, dryers, washer/dryers, parking meters, packaging (e.g., electromechanical systems (EMS), MEMS and non-MEMS), aesthetic structures (e.g., display of images on a piece of jewelry) and a variety of electromechanical systems devices. The teachings herein also can be used in non-display applications such as, but not limited to, electronic switching devices, radio frequency filters, sensors, accelerometers, gyroscopes, motion-sensing devices, magnetometers, inertial components for consumer electronics, parts of consumer electronics products, varactors, liquid crystal devices, electrophoretic devices, drive schemes, manufacturing processes and electronic test equipment. Thus, the teachings are not intended to be limited to the implementations depicted solely in the Figures, but instead have wide applicability as will be readily apparent to one having ordinary skill in the art.

Field-sequential color techniques can be applied to reflective displays, including but not limited to IMOD displays, using field-sequential front lights that may include color LEDs. Such implementations can provide a number of potential benefits. However, it is not apparent how one could implement known temporal grayscale techniques with such field-sequential color methods in a reflective display.

According to some implementations provided herein, a reflective mode display may include three or more different subpixel types, each of which corresponds to a color. Data for each color may be written sequentially to subpixels for that color, while subpixels of the remaining colors are written to black. Alternatively, data for each color may be written sequentially to all subpixels of the display. Flashing of a corresponding colored light, e.g., from a front light of the display, may be timed to follow a process of writing data for that color.

The term “field” may be used to refer to a portion of a data frame that corresponds to a particular color. A “field” may include a time interval during which data for a particular color are written and may further include a time interval during which a display is illuminated with light of that color. For example, a “red field” may include a time during which red data of a frame of image data are written to some or all subpixels of a display and during which the subpixels are illuminated with red light. In some implementations, a field may include a time interval between illuminating a display with a first color and writing data for a second color.

Some implementations may involve using colors other than the primary field color to produce grayscale. For example, the primary field color may correspond to an MSB and the other colors may correspond to two other two bits of a three-bit group. For the red field, the red subpixel may be driven according to the MSB, the green subpixel may be driven according to the next bit and the blue subpixel may be driven according to the LSB. In this manner, eight different brightness levels may be obtained for each field color. Other implementations may involve more or fewer bits and brightness levels. In some two-bit examples, the field color may correspond to an MSB and the other colors may correspond to an LSB.

Particular implementations of the subject matter described in this disclosure can be implemented to realize one or more of the following potential advantages. In some implementations, the color gamut of a reflective display may be increased for operation in low ambient light conditions. Moreover, some such implementations have the advantage of being able to increase the overall time for writing an image data frame without causing noticeable flicker. Some of the additional time may be used to increase the time during which colored light is flashed from a front light, thereby increasing brightness and color saturation. Alternatively, the longer time for writing an image data frame may be used to reduce power consumption of the display. Some implementations of displays described herein may be less susceptible to color shifts when the viewing angle is changed.

Implementations that include the novel grayscale methods described herein may provide additional potential advantages. Three-bit implementations, having eight different brightness levels for each field color, can produce substantial improvements in image quality. The additional brightness levels can produce a smoother, less grainy image with more gradual color transitions. Even two-bit implementations can produce noticeable improvements in image quality.

Although most of the description herein pertains to interferometric modulator displays, many such implementations could be used to advantage in other types of reflective displays, including but not limited to cholesteric LCD displays, transflective LCD displays, electrofluidic displays, electrophoretic displays and displays based on electro-wetting technology. Moreover, while the interferometric modulator displays described herein generally include red, blue and green subpixels, many implementations described herein could be used in reflective displays having other colors of subpixels, e.g., having violet, yellow-orange and yellow-green subpixels. Moreover, many implementations described herein could be used in reflective displays having more colors of subpixels, e.g., having subpixels corresponding to 4, 5 or more colors. Some such implementations may include subpixels corresponding to red, blue, green and yellow. Alternative implementations may include subpixels corresponding to red, blue, green, yellow and cyan.

One example of a suitable EMS or MEMS device, to which the described implementations may apply, is a reflective display device. Reflective display devices can incorporate interferometric modulators (IMODs) to selectively absorb and/or reflect light incident thereon using principles of optical interference. IMODs can include an absorber, a reflector that is movable with respect to the absorber, and an optical resonant cavity defined between the absorber and the reflector. The reflector can be moved to two or more different positions, which can change the size of the optical resonant cavity and thereby affect the reflectance of the interferometric modulator. The reflectance spectrums of IMODs can create fairly broad spectral bands which can be shifted across the visible wavelengths to generate different colors. The position of the spectral band can be adjusted by changing the thickness of the optical resonant cavity, e.g., by changing the position of the reflector.

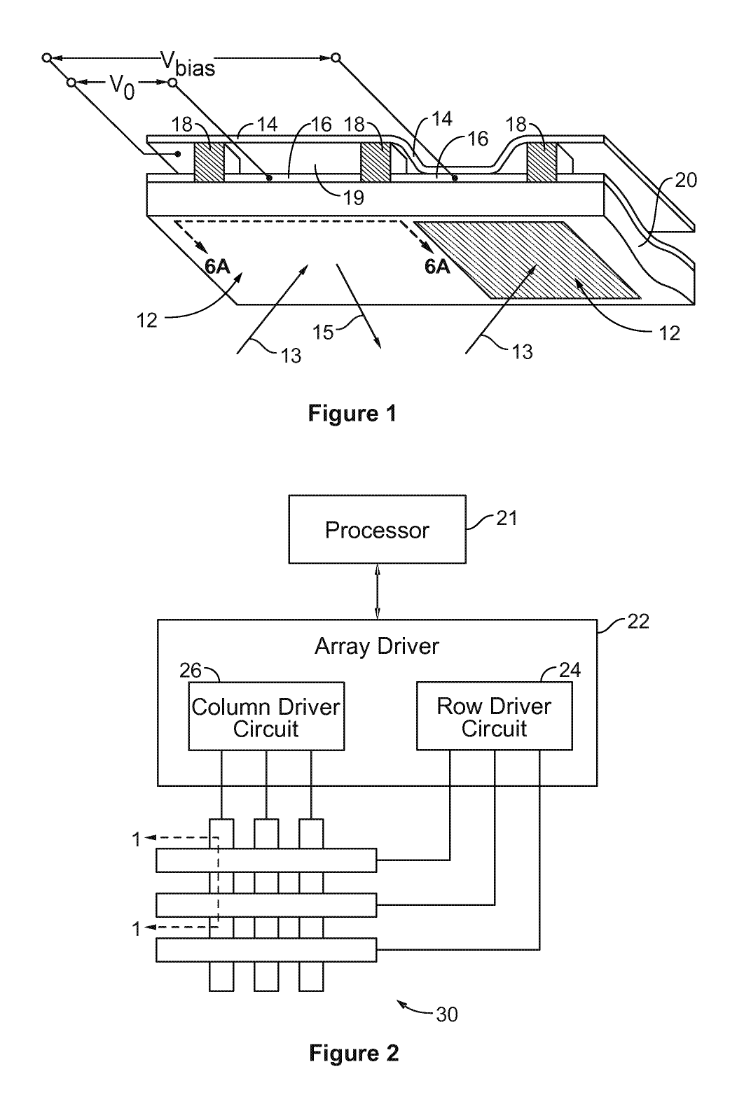

FIG. 1 shows an example of an isometric view depicting two adjacent pixels in a series of pixels of an interferometric modulator (IMOD) display device. The IMOD display device includes one or more interferometric MEMS display elements. In these devices, the pixels of the MEMS display elements can be in either a bright or dark state. In the bright (“relaxed,” “open” or “on”) state, the display element reflects a large portion of incident visible light, e.g., to a user. Conversely, in the dark (“actuated,” “closed” or “off”) state, the display element reflects little incident visible light. In some implementations, the light reflectance properties of the on and off states may be reversed. MEMS pixels can be configured to reflect predominantly at particular wavelengths allowing for a color display in addition to black and white.

The IMOD display device can include a row/column array of IMODs. Each IMOD can include a pair of reflective layers, i.e., a movable reflective layer and a fixed partially reflective layer, positioned at a variable and controllable distance from each other to form an air gap (also referred to as an optical gap or cavity). The movable reflective layer may be moved between at least two positions. In a first position, i.e., a relaxed position, the movable reflective layer can be positioned at a relatively large distance from the fixed partially reflective layer. In a second position, i.e., an actuated position, the movable reflective layer can be positioned more closely to the partially reflective layer. Incident light that reflects from the two layers can interfere constructively or destructively depending on the position of the movable reflective layer, producing either an overall reflective or non-reflective state for each pixel. In some implementations, the IMOD may be in a reflective state when unactuated, reflecting light within the visible spectrum, and may be in a dark state when unactuated, reflecting light outside of the visible range (e.g., infrared light). In some other implementations, however, an IMOD may be in a dark state when unactuated, and in a reflective state when actuated. In some implementations, the introduction of an applied voltage can drive the pixels to change states. In some other implementations, an applied charge can drive the pixels to change states.

The depicted portion of the pixel array in FIG. 1 includes two adjacent interferometric modulators 12. In the IMOD 12 on the left (as illustrated), a movable reflective layer 14 is illustrated in a relaxed position at a predetermined distance from an optical stack 16, which includes a partially reflective layer. The voltage V₀ applied across the IMOD 12 on the left is insufficient to cause actuation of the movable reflective layer 14. In the IMOD 12 on the right, the movable reflective layer 14 is illustrated in an actuated position near or adjacent the optical stack 16. The voltage V_{bias} applied across the IMOD 12 on the right is sufficient to maintain the movable reflective layer 14 in the actuated position.

In FIG. 1, the reflective properties of pixels 12 are generally illustrated with arrows 13 indicating light incident upon the pixels 12, and light 15 reflecting from the IMOD 12 on the left. Although not illustrated in detail, it will be understood by one having ordinary skill in the art that most of the light 13 incident upon the pixels 12 will be transmitted through the transparent substrate 20, toward the optical stack 16. A portion of the light incident upon the optical stack 16 will be transmitted through the partially reflective layer of the optical stack 16, and a portion will be reflected back through the transparent substrate 20. The portion of light 13 that is transmitted through the optical stack 16 will be reflected at the movable reflective layer 14, back toward (and through) the transparent substrate 20. Interference (constructive or destructive) between the light reflected from the partially reflective layer of the optical stack 16 and the light reflected from the movable reflective layer 14 will determine the wavelength(s) of light 15 reflected from the IMOD 12.

The optical stack 16 can include a single layer or several layers. The layer(s) can include one or more of an electrode layer, a partially reflective and partially transmissive layer and a transparent dielectric layer. In some implementations, the optical stack 16 is electrically conductive, partially transparent and partially reflective, and may be fabricated, for example, by depositing one or more of the above layers onto a transparent substrate 20. The electrode layer can be formed from a variety of materials, such as various metals, for example indium tin oxide (ITO). The partially reflective layer can be formed from a variety of materials that are partially reflective, such as various metals, e.g., chromium (Cr), semiconductors, and dielectrics. The partially reflective layer can be formed of one or more layers of materials, and each of the layers can be formed of a single material or a combination of materials. In some implementations, the optical stack 16 can include a single semi-transparent thickness of metal or semiconductor which serves as both an optical absorber and conductor, while different, more conductive layers or portions (e.g., of the optical stack 16 or of other structures of the IMOD) can serve to bus signals between IMOD pixels. The optical stack 16 also can include one or more insulating or dielectric layers covering one or more conductive layers or a conductive/absorptive layer.

In some implementations, the layer(s) of the optical stack 16 can be patterned into parallel strips, and may form row electrodes in a display device as described further below. As will be understood by one having skill in the art, the term “patterned” is used herein to refer to masking as well as etching processes. In some implementations, a highly conductive and reflective material, such as aluminum (Al), may be used for the movable reflective layer 14, and these strips may form column electrodes in a display device. The movable reflective layer 14 may be formed as a series of parallel strips of a deposited metal layer or layers (orthogonal to the row electrodes of the optical stack 16) to form columns deposited on top of posts 18 and an intervening sacrificial material deposited between the posts 18. When the sacrificial material is etched away, a defined gap 19, or optical cavity, can be formed between the movable reflective layer 14 and the optical stack 16. In some implementations, the spacing between posts 18 may be approximately 1-1000 um, while the gap 19 may be less than about 10,000 Angstroms (Å).

In some implementations, each pixel of the IMOD, whether in the actuated or relaxed state, is essentially a capacitor formed by the fixed and moving reflective layers. When no voltage is applied, the movable reflective layer 14 remains in a mechanically relaxed state, as illustrated by the IMOD 12 on the left in FIG. 1, with the gap 19 between the movable reflective layer 14 and optical stack 16. However, when a potential difference, e.g., voltage, is applied to at least one of a selected row and column, the capacitor formed at the intersection of the row and column electrodes at the corresponding pixel becomes charged, and electrostatic forces pull the electrodes together. If the applied voltage exceeds a threshold, the movable reflective layer 14 can deform and move near or against the optical stack 16. A dielectric layer (not shown) within the optical stack 16 may prevent shorting and control the separation distance between the layers 14 and 16, as illustrated by the actuated IMOD 12 on the right in FIG. 1. The behavior is the same regardless of the polarity of the applied potential difference. Though a series of pixels in an array may be referred to in some instances as “rows” or “columns,” a person having ordinary skill in the art will readily understand that referring to one direction as a “row” and another as a “column” is arbitrary. Restated, in some orientations, the rows can be considered columns, and the columns considered to be rows. Furthermore, the display elements may be evenly arranged in orthogonal rows and columns (an “array”), or arranged in non-linear configurations, for example, having certain positional offsets with respect to one another (a “mosaic”). The terms “array” and “mosaic” may refer to either configuration. Thus, although the display is referred to as including an “array” or “mosaic,” the elements themselves need not be arranged orthogonally to one another, or disposed in an even distribution, in any instance, but may include arrangements having asymmetric shapes and unevenly distributed elements.

FIG. 2 shows an example of a system block diagram illustrating an electronic device incorporating a 3×3 interferometric modulator display. The electronic device includes a processor 21 that may be configured to execute one or more software modules. In addition to executing an operating system, the processor 21 may be configured to execute one or more software applications, including a web browser, a telephone application, an email program, or other software application.

The processor 21 can be configured to communicate with an array driver 22. The array driver 22 can include a row driver circuit 24 and a column driver circuit 26 that provide signals to, e.g., a display array or panel 30. The cross section of the IMOD display device illustrated in FIG. 1 is shown by the lines 1-1 in FIG. 2. Although FIG. 2 illustrates a 3×3 array of IMODs for the sake of clarity, the display array 30 may contain a very large number of IMODs, and may have a different number of IMODs in rows than in columns, and vice versa.

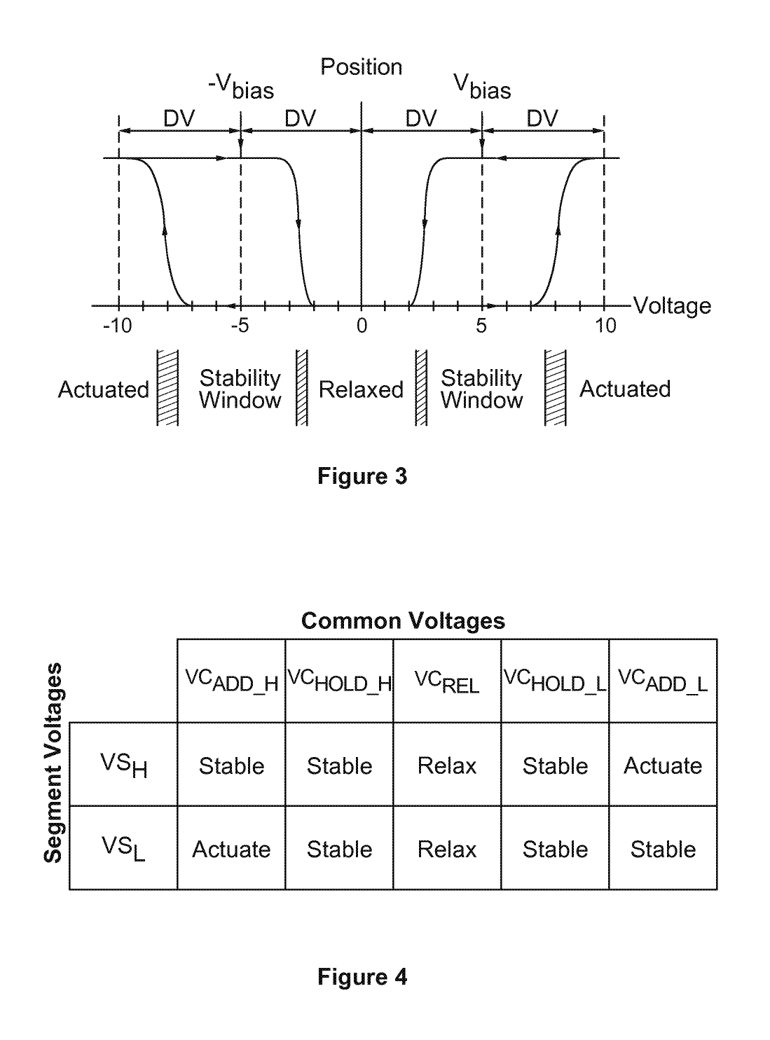

FIG. 3 shows an example of a diagram illustrating movable reflective layer position versus applied voltage for the interferometric modulator of FIG. 1. For MEMS interferometric modulators, the row/column (i.e., common/segment) write procedure may take advantage of a hysteresis property of these devices as illustrated in FIG. 3. An interferometric modulator may use, for example, about a 10-volt potential difference to cause the movable reflective layer, or mirror, to change from the relaxed state to the actuated state. When the voltage is reduced from that value, the movable reflective layer maintains its state as the voltage drops back below, e.g., 10 volts, however, the movable reflective layer does not relax completely until the voltage drops below 2 volts. Thus, a range of voltage, approximately 3 to 7 volts, as shown in FIG. 3, exists where there is a window of applied voltage within which the device is stable in either the relaxed or actuated state. This is referred to herein as the “hysteresis window” or “stability window.” For a display array 30 having the hysteresis characteristics of FIG. 3, the row/column write procedure can be designed to address one or more rows at a time, such that during the addressing of a given row, pixels in the addressed row that are to be actuated are exposed to a voltage difference of about 10 volts, and pixels that are to be relaxed are exposed to a voltage difference of near zero volts. After addressing, the pixels are exposed to a steady state or bias voltage difference of approximately 5-volts such that they remain in the previous strobing state. In this example, after being addressed, each pixel sees a potential difference within the “stability window” of about 3-7 volts. This hysteresis property feature enables the pixel design, e.g., illustrated in FIG. 1, to remain stable in either an actuated or relaxed pre-existing state under the same applied voltage conditions. Since each IMOD pixel, whether in the actuated or relaxed state, is essentially a capacitor formed by the fixed and moving reflective layers, this stable state can be held at a steady voltage within the hysteresis window without substantially consuming or losing power. Moreover, essentially little or no current flows into the IMOD pixel if the applied voltage potential remains substantially fixed.

In some implementations, a frame of an image may be created by applying data signals in the form of “segment” voltages along the set of column electrodes, in accordance with the desired change (if any) to the state of the pixels in a given row. Each row of the array can be addressed in turn, such that the frame is written one row at a time. To write the desired data to the pixels in a first row, segment voltages corresponding to the desired state of the pixels in the first row can be applied on the column electrodes, and a first row pulse in the form of a specific “common” voltage or signal can be applied to the first row electrode. The set of segment voltages can then be changed to correspond to the desired change (if any) to the state of the pixels in the second row, and a second common voltage can be applied to the second row electrode. In some implementations, the pixels in the first row are unaffected by the change in the segment voltages applied along the column electrodes, and remain in the state they were set to during the first common voltage row pulse. This process may be repeated for the entire series of rows, or alternatively, columns, in a sequential fashion to produce the image frame. The frames can be refreshed and/or updated with new image data by continually repeating this process at some desired number of frames per second.

The combination of segment and common signals applied across each pixel (that is, the potential difference across each pixel) determines the resulting state of each pixel. FIG. 4 shows an example of a table illustrating various states of an interferometric modulator when various common and segment voltages are applied. As will be readily understood by one having ordinary skill in the art, the “segment” voltages can be applied to either the column electrodes or the row electrodes, and the “common” voltages can be applied to the other of the column electrodes or the row electrodes.

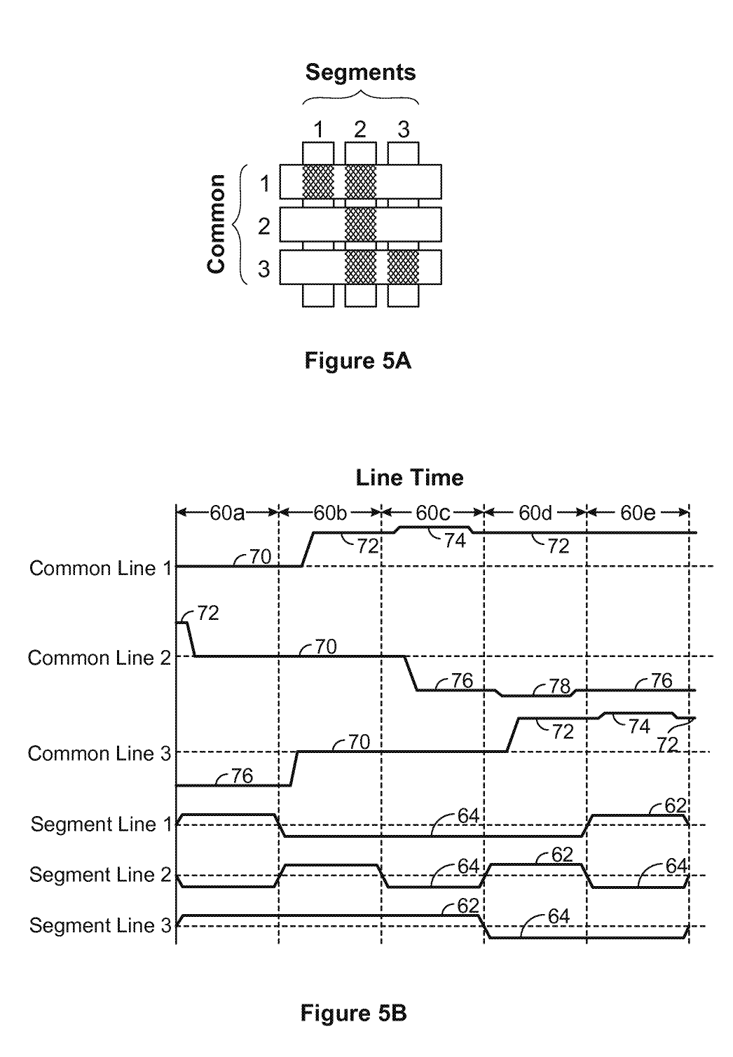

As illustrated in FIG. 4 (as well as in the timing diagram shown in FIG. 5B), when a release voltage VC_{REL} is applied along a common line, all interferometric modulator elements along the common line will be placed in a relaxed state, alternatively referred to as a released or unactuated state, regardless of the voltage applied along the segment lines, i.e., high segment voltage VS_{H} and low segment voltage VS_{L}. In particular, when the release voltage VC_{REL} is applied along a common line, the potential voltage across the modulator (alternatively referred to as a pixel voltage) is within the relaxation window (see FIG. 3, also referred to as a release window) both when the high segment voltage VS_{H} and the low segment voltage VS_{L} are applied along the corresponding segment line for that pixel.

When a hold voltage is applied on a common line, such as a high hold voltage VC_{HOLD H} or a low hold voltage VC_{HOLD}_{_{—}}_{L}, the state of the interferometric modulator will remain constant. For example, a relaxed IMOD will remain in a relaxed position, and an actuated IMOD will remain in an actuated position. The hold voltages can be selected such that the pixel voltage will remain within a stability window both when the high segment voltage VS_{H} and the low segment voltage VS_{L} are applied along the corresponding segment line. Thus, the segment voltage swing, i.e., the difference between the high VS_{H} and low segment voltage VS_{L}, is less than the width of either the positive or the negative stability window.

When an addressing, or actuation, voltage is applied on a common line, such as a high addressing voltage VC_{ADD}_{_{—}}_{H} or a low addressing voltage VC_{ADD}_{_{—}}_{L}, data can be selectively written to the modulators along that line by application of segment voltages along the respective segment lines. The segment voltages may be selected such that actuation is dependent upon the segment voltage applied. When an addressing voltage is applied along a common line, application of one segment voltage will result in a pixel voltage within a stability window, causing the pixel to remain unactuated. In contrast, application of the other segment voltage will result in a pixel voltage beyond the stability window, resulting in actuation of the pixel. The particular segment voltage which causes actuation can vary depending upon which addressing voltage is used. In some implementations, when the high addressing voltage VC_{ADD}_{_{—}}_{H} is applied along the common line, application of the high segment voltage VS_{H} can cause a modulator to remain in its current position, while application of the low segment voltage VS_{L} can cause actuation of the modulator. As a corollary, the effect of the segment voltages can be the opposite when a low addressing voltage VC_{ADD}_{_{—}}_{L} is applied, with high segment voltage VS_{H} causing actuation of the modulator, and low segment voltage VS_{L} having no effect (i.e., remaining stable) on the state of the modulator.

In some implementations, hold voltages, address voltages, and segment voltages may be used which always produce the same polarity potential difference across the modulators. In some other implementations, signals can be used which alternate the polarity of the potential difference of the modulators. Alternation of the polarity across the modulators (that is, alternation of the polarity of write procedures) may reduce or inhibit charge accumulation which could occur after repeated write operations of a single polarity.

FIG. 5A shows an example of a diagram illustrating a frame of display data in the 3x3 interferometric modulator display of FIG. 2. FIG. 5B shows an example of a timing diagram for common and segment signals that may be used to write the frame of display data illustrated in FIG. 5A. The signals can be applied to the, e.g., 3×3 array of FIG. 2, which will ultimately result in the line time 60e display arrangement illustrated in FIG. 5A. The actuated modulators in FIG. 5A are in a dark-state, i.e., where a substantial portion of the reflected light is outside of the visible spectrum so as to result in a dark appearance to, e.g., a viewer. Prior to writing the frame illustrated in FIG. 5A, the pixels can be in any state, but the write procedure illustrated in the timing diagram of FIG. 5B presumes that each modulator has been released and resides in an unactuated state before the first line time 60a.

During the first line time 60a, a release voltage 70 is applied on common line 1; the voltage applied on common line 2 begins at a high hold voltage 72 and moves to a release voltage 70; and a low hold voltage 76 is applied along common line 3. Thus, the modulators (common 1, segment 1), (1,2) and (1,3) along common line 1 remain in a relaxed, or unactuated, state for the duration of the first line time 60a, the modulators (2,1), (2,2) and (2,3) along common line 2 will move to a relaxed state, and the modulators (3,1), (3,2) and (3,3) along common line 3 will remain in their previous state. With reference to FIG. 4, the segment voltages applied along segment lines 1, 2 and 3 will have no effect on the state of the interferometric modulators, as none of common lines 1, 2 or 3 are being exposed to voltage levels causing actuation during line time 60a (i.e., VC_{REL}-relax and VC_{HOLD}_{_{—}}_{L}-stable).

During the second line time 60b, the voltage on common line 1 moves to a high hold voltage 72, and all modulators along common line 1 remain in a relaxed state regardless of the segment voltage applied because no addressing, or actuation, voltage was applied on the common line 1. The modulators along common line 2 remain in a relaxed state due to the application of the release voltage 70, and the modulators (3,1), (3,2) and (3,3) along common line 3 will relax when the voltage along common line 3 moves to a release voltage 70.

During the third line time 60c, common line 1 is addressed by applying a high address voltage 74 on common line 1. Because a low segment voltage 64 is applied along segment lines 1 and 2 during the application of this address voltage, the pixel voltage across modulators (1,1) and (1,2) is greater than the high end of the positive stability window (i.e., the voltage differential exceeded a predefined threshold) of the modulators, and the modulators (1,1) and (1,2) are actuated. Conversely, because a high segment voltage 62 is applied along segment line 3, the pixel voltage across modulator (1,3) is less than that of modulators (1,1) and (1,2), and remains within the positive stability window of the modulator; modulator (1,3) thus remains relaxed. Also during line time 60c, the voltage along common line 2 decreases to a low hold voltage 76, and the voltage along common line 3 remains at a release voltage 70, leaving the modulators along common lines 2 and 3 in a relaxed position.

During the fourth line time 60d, the voltage on common line 1 returns to a high hold voltage 72, leaving the modulators along common line 1 in their respective addressed states. The voltage on common line 2 is decreased to a low address voltage 78. Because a high segment voltage 62 is applied along segment line 2, the pixel voltage across modulator (2,2) is below the lower end of the negative stability window of the modulator, causing the modulator (2,2) to actuate. Conversely, because a low segment voltage 64 is applied along segment lines 1 and 3, the modulators (2,1) and (2,3) remain in a relaxed position. The voltage on common line 3 increases to a high hold voltage 72, leaving the modulators along common line 3 in a relaxed state.

Finally, during the fifth line time 60e, the voltage on common line 1 remains at high hold voltage 72, and the voltage on common line 2 remains at a low hold voltage 76, leaving the modulators along common lines 1 and 2 in their respective addressed states. The voltage on common line 3 increases to a high address voltage 74 to address the modulators along common line 3. As a low segment voltage 64 is applied on segment lines 2 and 3, the modulators (3,2) and (3,3) actuate, while the high segment voltage 62 applied along segment line 1 causes modulator (3,1) to remain in a relaxed position. Thus, at the end of the fifth line time 60e, the 3×3 pixel array is in the state shown in FIG. 5A, and will remain in that state as long as the hold voltages are applied along the common lines, regardless of variations in the segment voltage which may occur when modulators along other common lines (not shown) are being addressed.

In the timing diagram of FIG. 5B, a given write procedure (i.e., line times 60a-60e) can include the use of either high hold and address voltages, or low hold and address voltages. Once the write procedure has been completed for a given common line (and the common voltage is set to the hold voltage having the same polarity as the actuation voltage), the pixel voltage remains within a given stability window, and does not pass through the relaxation window until a release voltage is applied on that common line. Furthermore, as each modulator is released as part of the write procedure prior to addressing the modulator, the actuation time of a modulator, rather than the release time, may determine the necessary line time. Specifically, in implementations in which the release time of a modulator is greater than the actuation time, the release voltage may be applied for longer than a single line time, as depicted in FIG. 5B. In some other implementations, voltages applied along common lines or segment lines may vary to account for variations in the actuation and release voltages of different modulators, such as modulators of different colors.

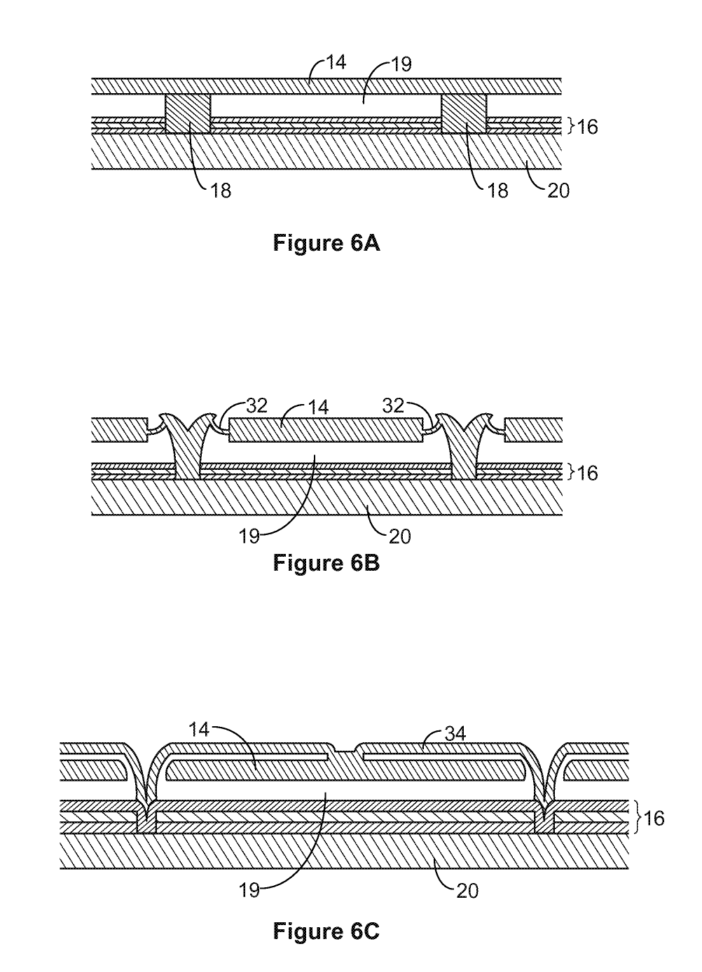

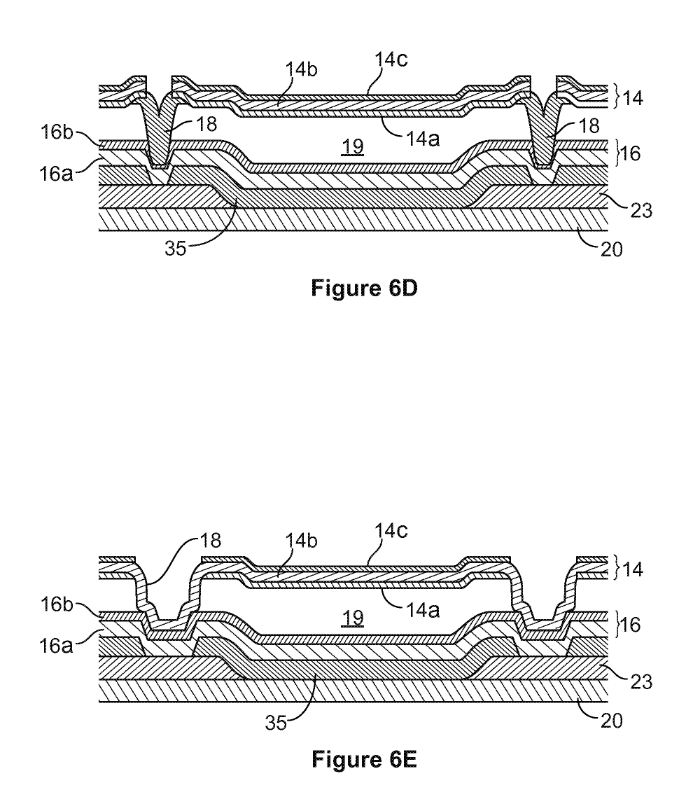

The details of the structure of interferometric modulators that operate in accordance with the principles set forth above may vary widely. For example, FIGS. 6A-6E show examples of cross-sections of varying implementations of interferometric modulators, including the movable reflective layer 14 and its supporting structures. FIG. 6A shows an example of a partial cross-section of the interferometric modulator display of FIG. 1, where a strip of metal material, i.e., the movable reflective layer 14 is deposited on supports 18 extending orthogonally from the substrate 20. In FIG. 6B, the movable reflective layer 14 of each IMOD is generally square or rectangular in shape and attached to supports at or near the corners, on tethers 32. In FIG. 6C, the movable reflective layer 14 is generally square or rectangular in shape and suspended from a deformable layer 34, which may include a flexible metal. The deformable layer 34 can connect, directly or indirectly, to the substrate 20 around the perimeter of the movable reflective layer 14. These connections are herein referred to as support posts. The implementation shown in FIG. 6C has additional benefits deriving from the decoupling of the optical functions of the movable reflective layer 14 from its mechanical functions, which are carried out by the deformable layer 34. This decoupling allows the structural design and materials used for the reflective layer 14 and those used for the deformable layer 34 to be optimized independently of one another.

FIG. 6D shows another example of an IMOD, where the movable reflective layer 14 includes a reflective sub-layer 14a. The movable reflective layer 14 rests on a support structure, such as support posts 18. The support posts 18 provide separation of the movable reflective layer 14 from the lower stationary electrode (i.e., part of the optical stack 16 in the illustrated IMOD) so that a gap 19 is formed between the movable reflective layer 14 and the optical stack 16, for example when the movable reflective layer 14 is in a relaxed position. The movable reflective layer 14 also can include a conductive layer 14c, which may be configured to serve as an electrode, and a support layer 14b. In this example, the conductive layer 14c is disposed on one side of the support layer 14b, distal from the substrate 20, and the reflective sub-layer 14a is disposed on the other side of the support layer 14b, proximal to the substrate 20. In some implementations, the reflective sub-layer 14a can be conductive and can be disposed between the support layer 14b and the optical stack 16. The support layer 14b can include one or more layers of a dielectric material, for example, silicon oxynitride (SiON) or silicon dioxide (SiO₂). In some implementations, the support layer 14b can be a stack of layers, such as, for example, an SiO₂/SiON/SiO₂ tri-layer stack. Either or both of the reflective sub-layer 14a and the conductive layer 14c can include, e.g., an Al alloy with about 0.5% copper (Cu), or another reflective metallic material. Employing conductive layers 14a, 14c above and below the dielectric support layer 14b can balance stresses and provide enhanced conduction. In some implementations, the reflective sub-layer 14a and the conductive layer 14c can be formed of different materials for a variety of design purposes, such as achieving specific stress profiles within the movable reflective layer 14.

As illustrated in FIG. 6D, some implementations also can include a black mask structure 23. The black mask structure 23 can be formed in optically inactive regions (e.g., between pixels or under posts 18) to absorb ambient or stray light. The black mask structure 23 also can improve the optical properties of a display device by inhibiting light from being reflected from or transmitted through inactive portions of the display, thereby increasing the contrast ratio. Additionally, the black mask structure 23 can be conductive and be configured to function as an electrical bussing layer. In some implementations, the row electrodes can be connected to the black mask structure 23 to reduce the resistance of the connected row electrode. The black mask structure 23 can be formed using a variety of methods, including deposition and patterning techniques. The black mask structure 23 can include one or more layers. For example, in some implementations, the black mask structure 23 includes a molybdenum-chromium (MoCr) layer that serves as an optical absorber, an SiO₂ layer, and an aluminum alloy that serves as a reflector and a bussing layer, with a thickness in the range of about 30-80 Å, 500-1000 Å, and 500-6000 Å, respectively. The one or more layers can be patterned using a variety of techniques, including photolithography and dry etching, including, for example, CF₄ and/or O₂ for the MoCr and SiO₂ layers and Cl₂ and/or BCl₃ for the aluminum alloy layer. In some implementations, the black mask 23 can be an etalon or interferometric stack structure. In such interferometric stack black mask structures 23, the conductive absorbers can be used to transmit or bus signals between lower, stationary electrodes in the optical stack 16 of each row or column. In some implementations, a spacer layer 35 can serve to generally electrically isolate the absorber layer 16a from the conductive layers in the black mask 23.

FIG. 6E shows another example of an IMOD, where the movable reflective layer 14 is self-supporting. In contrast with FIG. 6D, the implementation of FIG. 6E does not include support posts 18. Instead, the movable reflective layer 14 contacts the underlying optical stack 16 at multiple locations, and the curvature of the movable reflective layer 14 provides sufficient support that the movable reflective layer 14 returns to the unactuated position of FIG. 6E when the voltage across the interferometric modulator is insufficient to cause actuation. The optical stack 16, which may contain a plurality of several different layers, is shown here for clarity including an optical absorber 16a, and a dielectric 16b. In some implementations, the optical absorber 16a may serve both as a fixed electrode and as a partially reflective layer.

In implementations such as those shown in FIGS. 6A-6E, the IMODs function as direct-view devices, in which images are viewed from the front side of the transparent substrate 20, i.e., the side opposite to that upon which the modulator is arranged. In these implementations, the back portions of the device (that is, any portion of the display device behind the movable reflective layer 14, including, for example, the deformable layer 34 illustrated in FIG. 6C) can be configured and operated upon without impacting or negatively affecting the image quality of the display device, because the reflective layer 14 optically shields those portions of the device. For example, in some implementations a bus structure (not illustrated) can be included behind the movable reflective layer 14 which provides the ability to separate the optical properties of the modulator from the electromechanical properties of the modulator, such as voltage addressing and the movements that result from such addressing. Additionally, the implementations of FIGS. 6A-6E can simplify processing, such as, e.g., patterning.

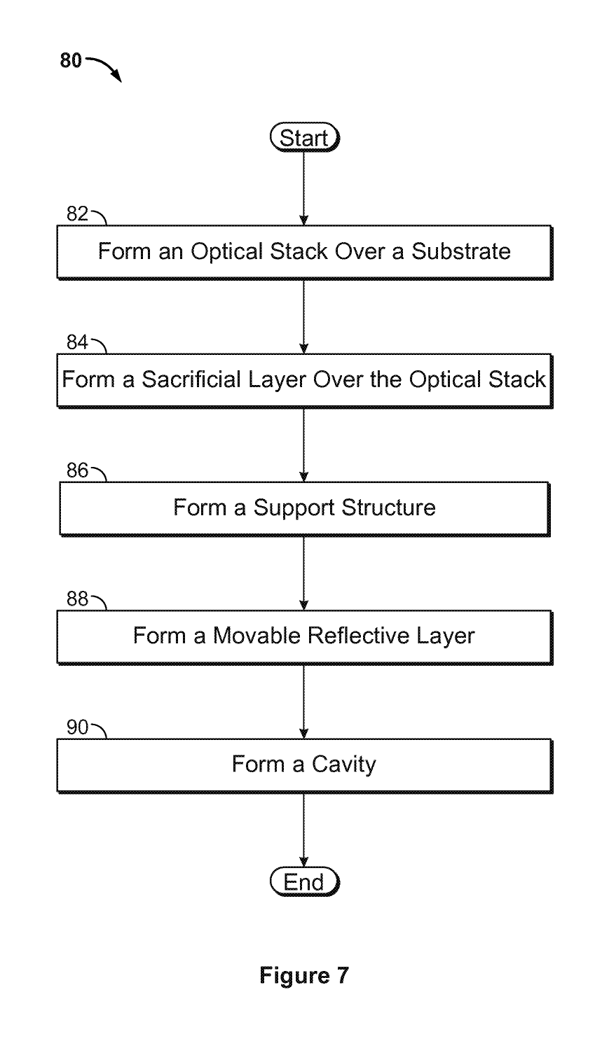

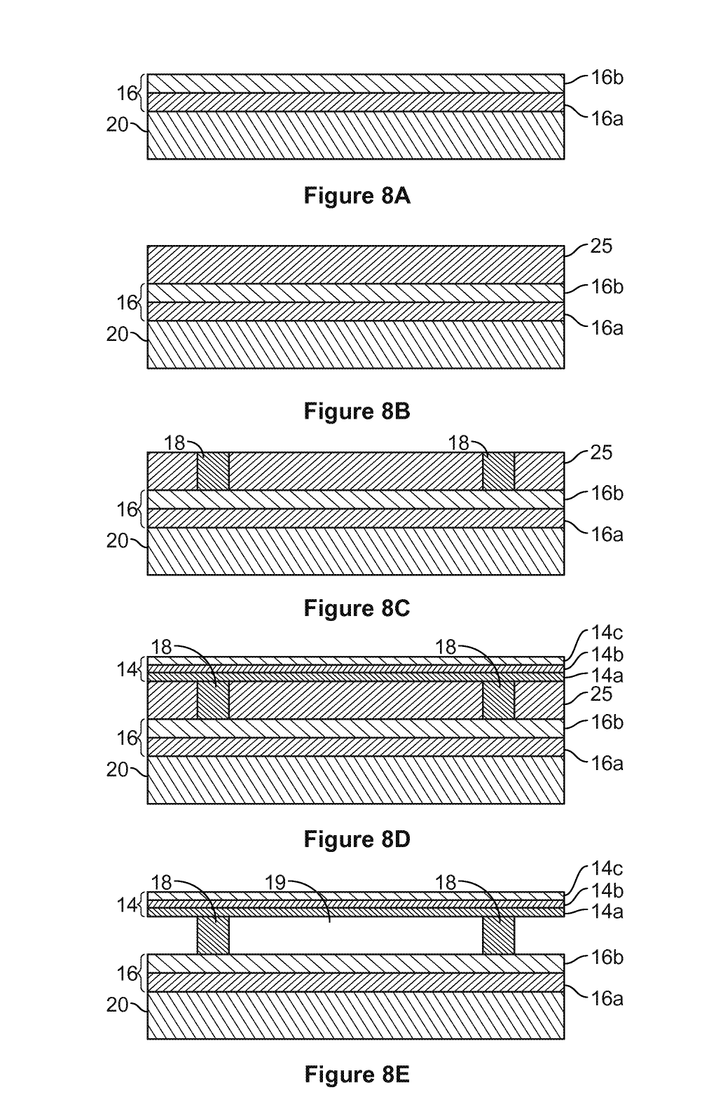

FIG. 7 shows an example of a flow diagram illustrating a manufacturing process 80 for an interferometric modulator, and FIGS. 8A-8E show examples of cross-sectional schematic illustrations of corresponding stages of such a manufacturing process 80. In some implementations, the manufacturing process 80 can be implemented to manufacture, e.g., interferometric modulators of the general type illustrated in FIGS. 1 and 6, in addition to other blocks not shown in FIG. 7. With reference to FIGS. 1, 6 and 7, the process 80 begins at block 82 with the formation of the optical stack 16 over the substrate 20. FIG. 8A illustrates such an optical stack 16 formed over the substrate 20. The substrate 20 may be a transparent substrate such as glass or plastic, it may be flexible or relatively stiff and unbending, and may have been subjected to prior preparation processes, e.g., cleaning, to facilitate efficient formation of the optical stack 16. As discussed above, the optical stack 16 can be electrically conductive, partially transparent and partially reflective and may be fabricated, for example, by depositing one or more layers having the desired properties onto the transparent substrate 20. In FIG. 8A, the optical stack 16 includes a multilayer structure having sub-layers 16a and 16b, although more or fewer sub-layers may be included in some other implementations. In some implementations, one of the sub-layers 16a, 16b can be configured with both optically absorptive and conductive properties, such as the combined conductor/absorber sub-layer 16a. Additionally, one or more of the sub-layers 16a, 16b can be patterned into parallel strips, and may form row electrodes in a display device. Such patterning can be performed by a masking and etching process or another suitable process known in the art. In some implementations, one of the sub-layers 16a, 16b can be an insulating or dielectric layer, such as sub-layer 16b that is deposited over one or more metal layers (e.g., one or more reflective and/or conductive layers). In addition, the optical stack 16 can be patterned into individual and parallel strips that form the rows of the display.

The process 80 continues at block 84 with the formation of a sacrificial layer 25 over the optical stack 16. The sacrificial layer 25 is later removed (e.g., at block 90) to form the cavity 19 and thus the sacrificial layer 25 is not shown in the resulting interferometric modulators 12 illustrated in FIG. 1. FIG. 8B illustrates a partially fabricated device including a sacrificial layer 25 formed over the optical stack 16. The formation of the sacrificial layer 25 over the optical stack 16 may include deposition of a xenon difluoride (XeF₂)-etchable material such as molybdenum (Mo) or amorphous silicon (Si), in a thickness selected to provide, after subsequent removal, a gap or cavity 19 (see also FIGS. 1 and 8E) having a desired design size. Deposition of the sacrificial material may be carried out using deposition techniques such as physical vapor deposition (PVD, e.g., sputtering), plasma-enhanced chemical vapor deposition (PECVD), thermal chemical vapor deposition (thermal CVD), or spin-coating.

The process 80 continues at block 86 with the formation of a support structure e.g., a post 18 as illustrated in FIGS. 1, 6 and 8C. The formation of the post 18 may include patterning the sacrificial layer 25 to form a support structure aperture, then depositing a material (e.g., a polymer or an inorganic material, e.g., silicon oxide) into the aperture to form the post 18, using a deposition method such as PVD, PECVD, thermal CVD, or spin-coating. In some implementations, the support structure aperture formed in the sacrificial layer can extend through both the sacrificial layer 25 and the optical stack 16 to the underlying substrate 20, so that the lower end of the post 18 contacts the substrate 20 as illustrated in FIG. 6A. Alternatively, as depicted in FIG. 8C, the aperture formed in the sacrificial layer 25 can extend through the sacrificial layer 25, but not through the optical stack 16. For example, FIG. 8E illustrates the lower ends of the support posts 18 in contact with an upper surface of the optical stack 16. The post 18, or other support structures, may be formed by depositing a layer of support structure material over the sacrificial layer 25 and patterning portions of the support structure material located away from apertures in the sacrificial layer 25. The support structures may be located within the apertures, as illustrated in FIG. 8C, but also can, at least partially, extend over a portion of the sacrificial layer 25. As noted above, the patterning of the sacrificial layer 25 and/or the support posts 18 can be performed by a patterning and etching process, but also may be performed by alternative etching methods.

The process 80 continues at block 88 with the formation of a movable reflective layer or membrane such as the movable reflective layer 14 illustrated in FIGS. 1, 6 and 8D. The movable reflective layer 14 may be formed by employing one or more deposition processes, e.g., reflective layer (e.g., aluminum, aluminum alloy) deposition, along with one or more patterning, masking, and/or etching processes. The movable reflective layer 14 can be electrically conductive, and referred to as an electrically conductive layer. In some implementations, the movable reflective layer 14 may include a plurality of sub-layers 14a, 14b, 14c as shown in FIG. 8D. In some implementations, one or more of the sub-layers, such as sub-layers 14a, 14c, may include highly reflective sub-layers selected for their optical properties, and another sub-layer 14b may include a mechanical sub-layer selected for its mechanical properties. Since the sacrificial layer 25 is still present in the partially fabricated interferometric modulator formed at block 88, the movable reflective layer 14 is typically not movable at this stage. A partially fabricated IMOD that contains a sacrificial layer 25 may also be referred to herein as an “unreleased” IMOD. As described above in connection with FIG. 1, the movable reflective layer 14 can be patterned into individual and parallel strips that form the columns of the display.

The process 80 continues at block 90 with the formation of a cavity, e.g., cavity 19 as illustrated in FIGS. 1, 6 and 8E. The cavity 19 may be formed by exposing the sacrificial material 25 (deposited at block 84) to an etchant. For example, an etchable sacrificial material such as Mo or amorphous Si may be removed by dry chemical etching, e.g., by exposing the sacrificial layer 25 to a gaseous or vaporous etchant, such as vapors derived from solid XeF₂ for a period of time that is effective to remove the desired amount of material, typically selectively removed relative to the structures surrounding the cavity 19. Other combinations of etchable sacrificial material and etching methods, e.g. wet etching and/or plasma etching, also may be used. Since the sacrificial layer 25 is removed during block 90, the movable reflective layer 14 is typically movable after this stage. After removal of the sacrificial material 25, the resulting fully or partially fabricated IMOD may be referred to herein as a “released” IMOD.

In some implementations, rows of an IMOD display can be scanned and written with different colors (e.g., red, green, and blue) sequentially, and then the corresponding colored light from a front light of the display may be flashed onto the display for a certain time after the rows are scanned. While writing data of a primary color of interest in subpixels of rows in the display, corresponding subpixels of the remaining primary colors may be written to black, or driven according to data for the color of interest, simultaneously.

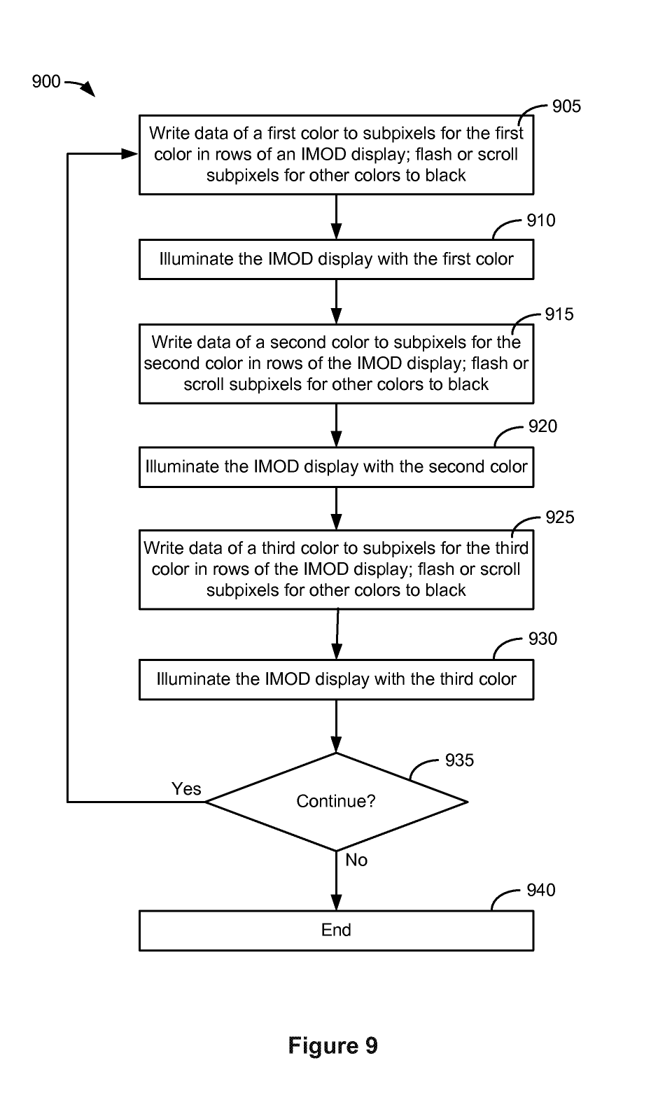

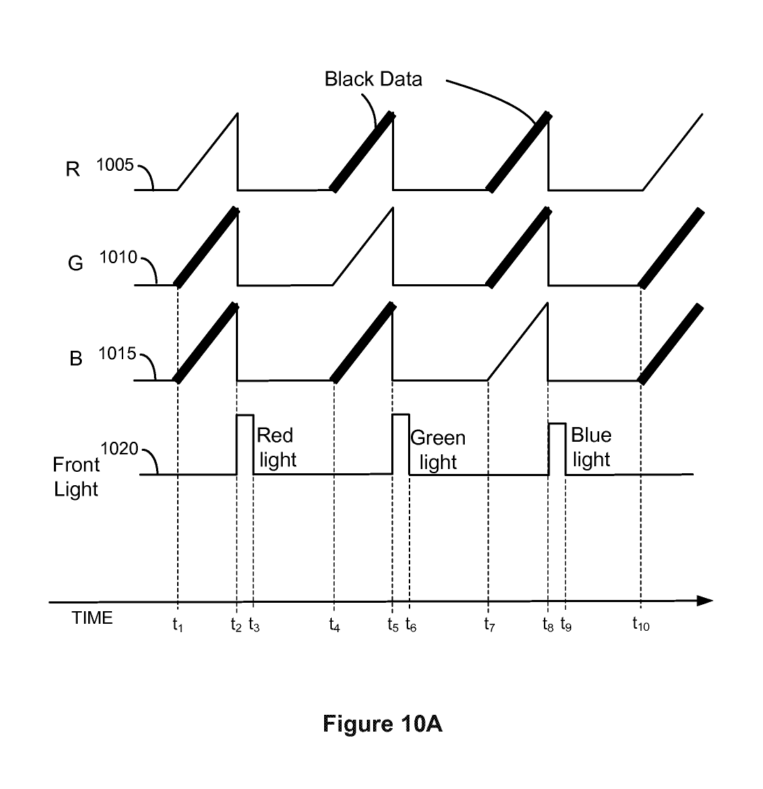

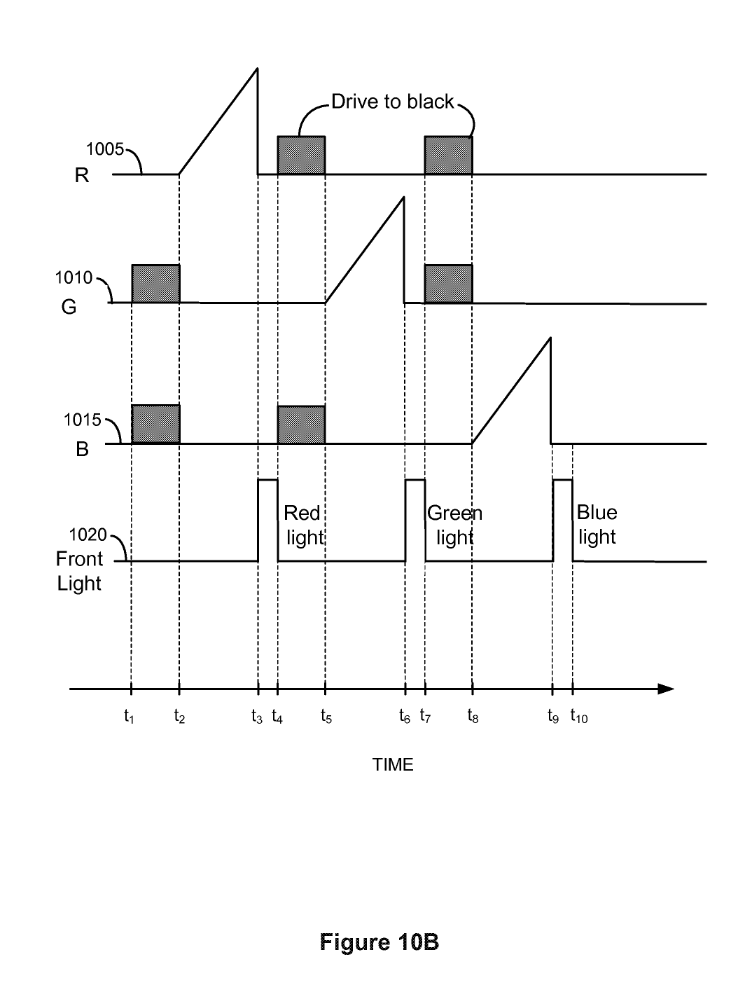

FIG. 9 shows an example of a flow diagram outlining processes of some methods described herein. FIG. 10A shows an example of a diagram that depicts how components of a reflective display may be controlled according to a method outlined in FIG. 9. FIG. 10B shows an example of a diagram that depicts how components of a reflective display may be controlled according to an alternative method outlined in FIG. 9. Such methods, as well as other methods described herein, may be performed by one or more processors, controllers, etc., such as those described with reference to FIGS. 2 through 5B and 28B.

Referring first to FIG. 9, method 900 begins with block 905, in which data corresponding to a first color are written to subpixels for the first color in rows of an IMOD display. Subpixels for all other colors are driven to black. In some implementations, subpixels for all other colors may be “flashed” to black at substantially the same time. One such implementation is described below with reference to FIG. 10B.

However, in the implementation depicted in FIG. 10A, subpixels for all other colors are “scrolled” to black row by row, as the data for the first color are written. In FIG. 10A, trace 1005 indicates how rows of red subpixels are driven, trace 1010 indicates how rows of green subpixels are driven, trace 1015 indicates how rows of blue subpixels are driven and trace 1020 indicates how a light source is controlled to illuminate the array of subpixels. In this example, the light source is a front light that includes red, green and blue light-emitting diodes (LEDs). Other types of light source may be used in other implementations. Beginning at time t₁, red data of a frame of image data are written to rows of red subpixels. At substantially the same time, the rows of green and blue subpixels are scrolled to black. The “drive” time for addressing the subpixel rows, from time t₁ until time t₂, may be on the order of a few milliseconds (ms), e.g., between 1 and 10 ms. In some implementations, this time may be on the order of 3 to 6 ms.

After all subpixels in the array have been addressed, the array of subpixels is illuminated with red light, from time t₂ until time t₃. (See block 910 of FIG. 9.) The illumination time may, for example, be on the order of 1 or more ms. In some implementations, there may be a short time (e.g., a few microseconds) between the time at which the last row of subpixels is addressed and the time at which the array of subpixels is illuminated. However, in alternative implementations, the array of subpixels may be illuminated before the last row of subpixels is addressed. For example, the array of subpixels may be illuminated after most, but not all, of the subpixels have been addressed (e.g., after approximately 70%, 75%, 80%, 85%, 90% or 95% of the subpixels have been addressed). The time interval between t₃ and t₄ (as well as the time interval between t₆ and t₇) may be made small, e.g., a few microseconds. In some implementations these time intervals are made as close to zero as is practicable, such that data for the next color are written immediately (or almost immediately) after the light source is turned off.

The time interval between t₁ and t₄ may be referred to herein as a “field,” which corresponds to a sub-unit of a frame during which data for a particular color are written and within which the display is illuminated with light of that color. In this example, the time interval between t₁ and t₄ may be referred to as a “red field,” because this first field corresponds to a time during which red data of a frame of image data are written to subpixels of the display and during which the subpixels are illuminated with red light. The entire frame of data extends from t₁ to t₁₀, after which time the next frame of data is written.

From time t₄ to time t₅, data of a second color are written to subpixels for the second color in rows of the array of subpixels, while subpixels for other colors are scrolled to black. (See block 915 of FIG. 9.) In the example shown in FIG. 10A, green data are written to the green subpixels while the red and blue subpixels are scrolled to black. Subsequently, the array of subpixels is illuminated with green light from time t₅ (or from a time just after time t₅) to time t₆. (See block 920 of FIG. 9.) In alternative implementations, the array of subpixels may be illuminated before the last row of subpixels is addressed. The time interval between t₄ and t₇ may be referred to herein as a “green field,” because this field corresponds to a time during which green data of a frame of image data are written to subpixels of the display and during which the subpixels are illuminated with green light.

Next, data of a third color are written to subpixels for the third color in rows of the array of subpixels, while subpixels for other colors are scrolled to black. (See block 925 of FIG. 9.) In the example shown in FIG. 10A, from time t₇ to time t₈ blue data are written to the blue subpixels while the red and green subpixels are scrolled to black. Subsequently, the array of subpixels is illuminated with blue light from time t₈ (or from a time just after time t₈) to time t₉. (See block 930 of FIG. 9.) In alternative implementations, the array of subpixels may be illuminated before the last row of subpixels is addressed. The time interval between t₇ and t₁₀ may be referred to herein as a “blue field,” because this field corresponds to a time during which blue data of a frame of image data are written to subpixels of the display and during which the subpixels are illuminated with blue light.

At this point, an entire frame of image data has been written to the subpixel array. The next frame of image data may be written to the subpixel array by returning to block 905 and repeating the above-described process for the next frame. Although in the above example (and other examples described herein) the sequence of colors is red/green/blue, the order in which the color data are written and the corresponding colored light is flashed does not matter and may differ in other implementations.

Referring now to FIG. 10B, a “flash to black” implementation will be described. In FIG. 10B, trace 1005 indicates how rows of red subpixels are driven, trace 1010 indicates how rows of green subpixels are driven, trace 1015 indicates how rows of blue subpixels are driven and trace 1020 indicates how a light source is controlled to illuminate the array of subpixels. In this example, the light source is a front light that includes red, green and blue light-emitting diodes (LEDs). Other types of light source may be used in other implementations. Beginning at time t₁, all of the rows of green and blue subpixels are flashed to black at substantially the same time. In some implementations, all of the rows of green and blue subpixels are flashed to black in a single line time by setting all common lines to a voltage higher than V_{actuate}. (See FIGS. 4 through 5B and the corresponding discussion above.) The time interval between t₁ and t₂ (as well as the time interval between t₄ and t₅ and between t₇ and t₈) may be made small, e.g., less than 1 ms.

Beginning at time t₂, red data of a frame of image data are written to rows of red subpixels. The “drive” time for writing data to the subpixel rows, from time t₂ until time t₃, may be on the order of a few milliseconds (ms), e.g., between 1 and 10 ms. In some implementations, this time may be on the order of 3 to 6 ms. In this example, all of the rows of green and blue subpixels kept in a black state from time t₂ until after the subpixel array is illuminated with red light. In alternative implementations, all of the rows of green and blue subpixels may be flashed to black during the time that red data are being written.

After all subpixels in the array have been addressed, the array of subpixels is illuminated with red light, in this example from time t₃ until time t₄. The time interval between t₁ and t₄ is another example of a red field. The illumination time may, for example, be on the order of 1 or more ms. In some implementations, there may be a short time (e.g., a few microseconds) between the time at which the last row of subpixels is addressed and the time at which the array of subpixels is illuminated. However, in alternative implementations, the array of subpixels may be illuminated before last row of subpixels is addressed. For example, the array of subpixels may be illuminated after most, but not all, of the subpixels have been addressed (e.g., after approximately 70%, 75%, 80%, 85%, 90% or 95% of the subpixels have been addressed).

Beginning at time t₄, all of the rows of red subpixels are flashed to black at substantially the same time. In alternative implementations, all of the rows of red subpixels may be flashed to black during the time that green data are being written. In this example, all of the rows of blue subpixels are also flashed to black. However, in alternative implementations, all of the rows of blue subpixels may be maintained in a black state from the time that they were previously flashed to black until after the subpixel array is illuminated with green light.

From time t₅ to time t₆, data of a second color are written to subpixels for the second color in rows of the array of subpixels, while subpixels for other colors are kept in a black state. In the example shown in FIG. 10B, green data are written to the green subpixels while the red and blue subpixels are kept in a black state. Subsequently, the array of subpixels is illuminated with green light from time t₆ (or from a time just after time t₆) to time t₇. In alternative implementations, the array of subpixels may be illuminated before the last row of subpixels is addressed.

Next, all of the rows of green subpixels are flashed to black at substantially the same time, starting at time t₇ in this example. The time interval between t₄ and t₇ is another example of a green field. In alternative implementations, all of the rows of green subpixels may be flashed to black during the time that blue data are being written. In this example, all of the rows of red subpixels are also flashed to black. However, in alternative implementations, all of the rows of red subpixels may be maintained in a black state from the time that they were previously flashed to black until after the subpixel array has been illuminated with blue light.

Data of a third color are written to subpixels for the third color in rows of the array of subpixels, while subpixels for other colors are kept in a black state. In the example shown in FIG. 10B, from time t₈ to time t₉ blue data are written to the blue subpixels while the red and green subpixels are kept in a black state. Subsequently, the array of subpixels is illuminated with blue light from time t₉ (or from a time just after time t₉) through time t₁₀. The time interval between t₇ and t₁₀ is another example of a blue field. In alternative implementations, the array of subpixels may be illuminated before the last row of subpixels is addressed.

At this point, an entire frame of image data has been written to the subpixel array. The next frame of image data may be written to the subpixel array by repeating the above-described process for the next frame. Although in the above example (and other examples described herein) the sequence of colors is red/green/blue, the order in which the color data are written and the corresponding colored light is flashed does not matter and may differ in other implementations.

Scrolling black and flash to black implementations have the advantage of increased color saturation, as compared to IMODs driven according to some conventional schemes, when the front light of a display is being used. When used in a relatively dark environment, the appearance is dominated by the light provided to the display by the front light. If the ambient light becomes bright enough, however, the reflective color will be dimmer than during typical IMOD display operation in reflective mode (about ⅓ as bright), because only 1 type of subpixel is “on” (not driven to black) at a time. Accordingly, in some instances it will be determined in block 935 that the scrolling black method will end. For example, it may be determined in block 935 that the operational mode of the display will be altered because of a change in ambient light conditions, because of an indication received from a user input device, etc. In some implementations, the display may be configured to provide vivid colors even under bright ambient light.

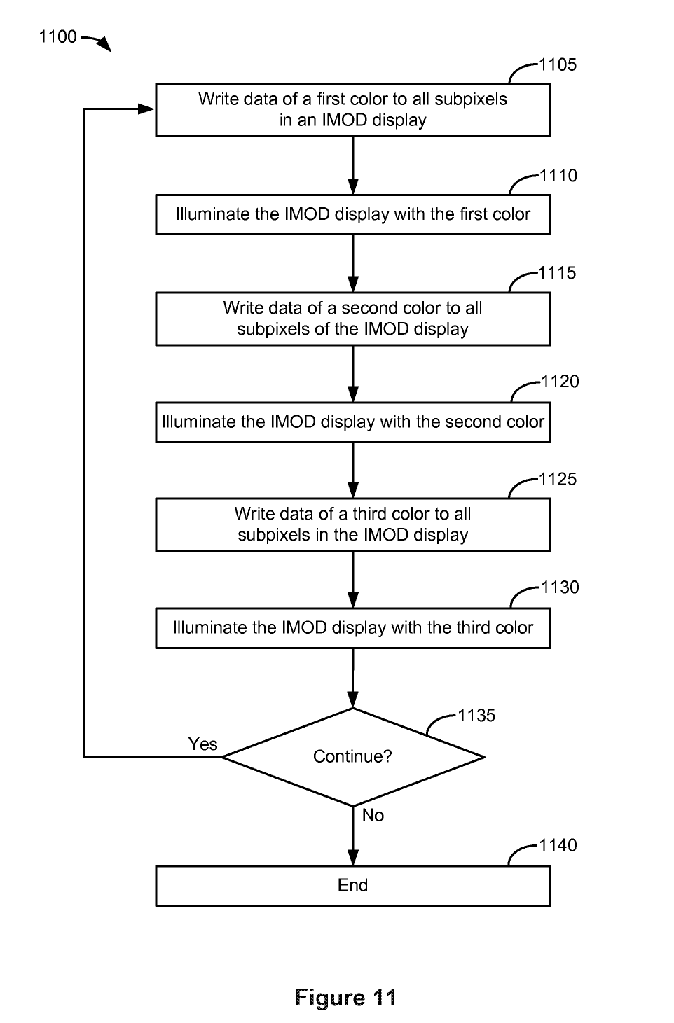

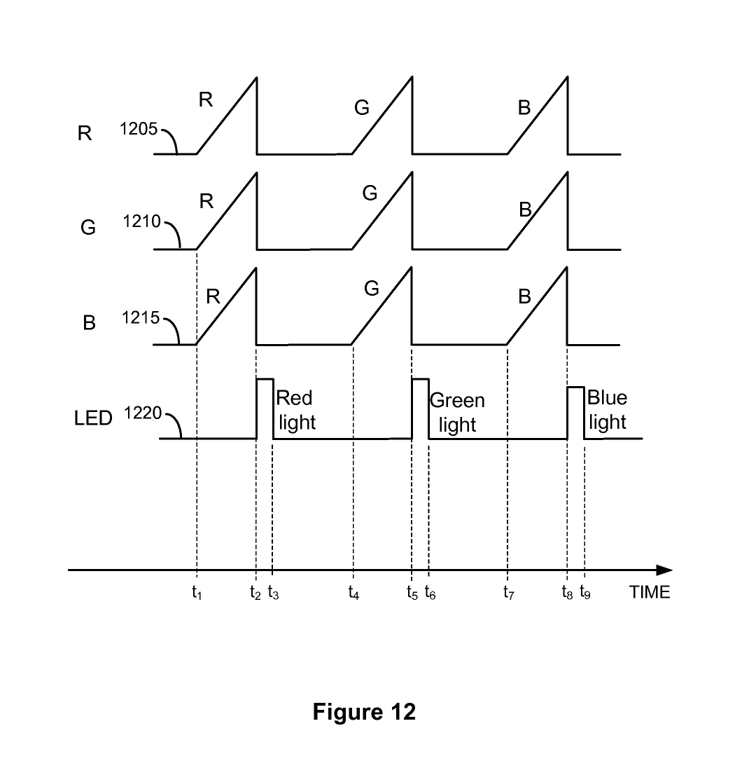

FIG. 11 shows an example of a flow diagram outlining processes of alternative methods described herein. FIG. 12 shows an example of a diagram that depicts how components of a reflective display may be controlled according to a method outlined in FIG. 11. In this example, the reflective display is an IMOD display. Referring first to FIG. 11, in block 1105 data of a first color are written to all subpixels in the IMOD display. In other words, data that would normally be written only to subpixels corresponding to a first color are written to all subpixels, regardless of to which color the subpixels correspond.

One example is shown in FIG. 12. In FIG. 12, trace 1205 indicates how rows of red subpixels are driven, trace 1210 indicates how rows of green subpixels are driven, trace 1215 indicates how rows of blue subpixels are driven and trace 1220 indicates how a light source is controlled to illuminate the array of subpixels. In this example, the light source is a front light that includes red, green and blue LEDs. Other types of light source may be used in other implementations. Beginning at time t₁, red data of a frame of image data are written to the rows of red subpixels, to the rows of green subpixels and to the rows of blue subpixels in a display. The time for addressing the subpixel rows, from time t₁ until time t₂, may be on the order of a few milliseconds (ms), e.g., between 1 and 10 ms.

In this example, the array of subpixels is illuminated with red light after all subpixels in the array have been addressed and written with red data of the frame of image data, from time t₂ (or from a time just after time t₂) until time t₃. (See block 1110 of FIG. 11.) However, in alternative implementations, the array of subpixels may be illuminated before the last row of subpixels is addressed. For example, the array of subpixels may be illuminated after most, but not all, of the subpixels have been addressed (e.g., after approximately 70%, 75%, 80%, 85%, 90% or 95% of the subpixels have been addressed). The illumination time may, for example, be on the order of 1 or more ms. The time interval between t₃ and t₄ (as well as the time interval between t₆ and t₇) may be made small, e.g., a few microseconds. In some implementations these time intervals are made as close to zero as is practicable, such that data for the next color are written immediately (or almost immediately) after the light source is turned off.

From time t₄ to time t₅, data of a second color are written to subpixels for the first, second and third colors in rows of the array of subpixels. (See block 1115 of FIG. 11.) In the example shown in FIG. 12, green data are written to the red subpixels, to the green subpixels and to the blue subpixels. Subsequently, the array of subpixels is illuminated with green light from time t₅ (or from a time just after time t₅) to time t₆. (See block 1120 of FIG. 11.) In alternative implementations, the array of subpixels may be illuminated before the last row of subpixels is addressed.

Next, data of a third color are written to all subpixels in the array of subpixels. (See block 1125 of FIG. 11.) In the example shown in FIG. 12, from time t₇ to time t₈ blue data are written to all subpixels in the array, including the red and green subpixels. Subsequently, the array of subpixels is illuminated with blue light from time t₈ (or from a time just after time t₈) to time t₉. (See block 1130 of FIG. 11.) In alternative implementations, the array of subpixels may be illuminated before the last row of subpixels is addressed.

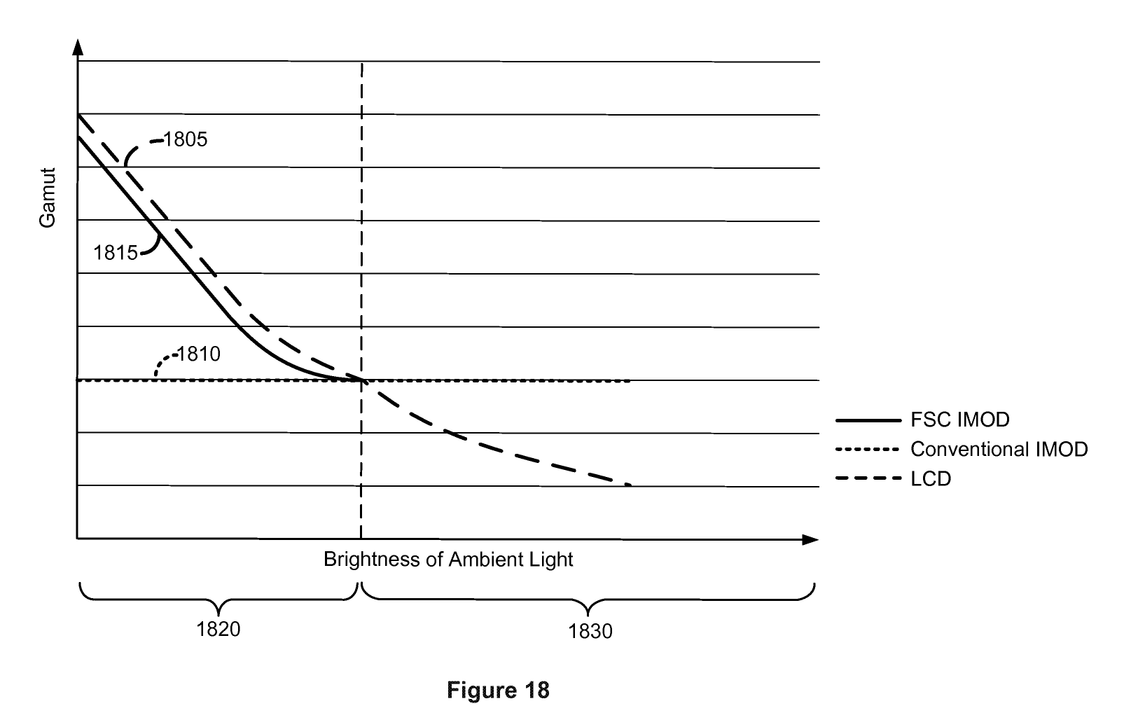

At this time, a frame of image data has been written to the subpixel array. It may then be determined whether to change the operational mode of the display or whether to continue controlling the display in accordance with method 1100. The next frame of image data may be written to the subpixel array in accordance with method 1100 by returning to block 1105 and repeating the above-described processes for the next frame. The determination in block 1135 of whether to change the operational mode of the display may be made, for example, in response to a change in ambient light conditions and/or in response to user input. If the ambient light is sufficiently bright while controlling a display in accordance with method 1100, the ambient light may make the display appear to be a black and white display instead of a color display. Therefore, it can be advantageous to change the operational mode of the display according to the brightness of ambient light. Some relevant methods of are described below with reference to FIGS. 18 through 20.

However, when used in conditions of low ambient light, method 1100 may result in greater brightness and color saturation than some conventional interferometric modulation subpixel illumination methods. Method 1100 may even result in greater brightness and color saturation than the “flash to black” and “scrolling black” implementations described above with reference to FIGS. 9 and 10A-B. However, this may depend on the spectral responses of the subpixels in the array.

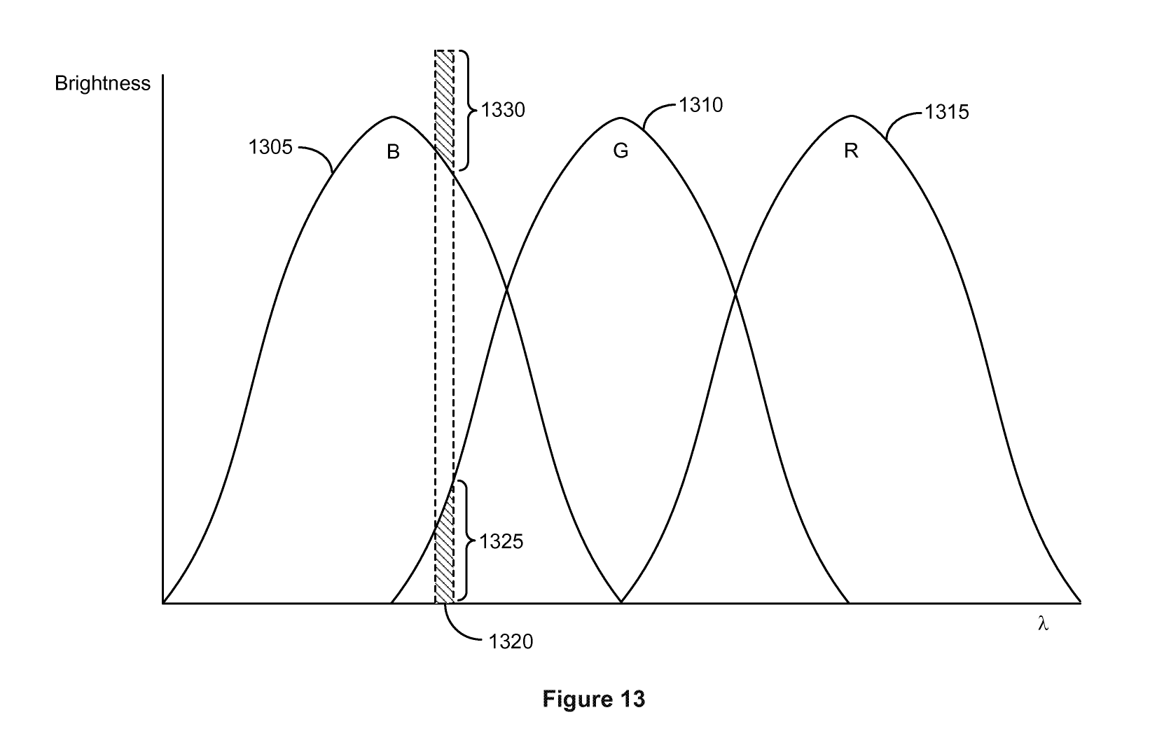

FIG. 13 shows an example of a graph of the spectral responses of three interferometric modulation subpixels, each of which corresponds to a different color. In this example, curve 1305 corresponds to the spectral response of blue subpixels, curve 1310 corresponds to the spectral response of green subpixels and curve 1315 corresponds to the spectral response of red subpixels in the subpixel array. In this example, the spectral response of the green subpixels substantially overlaps with the spectral response of the blue subpixels and the spectral response of the red subpixels.

Accordingly, when the green subpixels are illuminated with some wavelengths of light in the blue range or the red range, the response of the green subpixels may provide additional blue or red color. For example, when the subpixel array is illuminated with light in wavelength range 1320, the green subpixels contribute an amount of brightness in the blue wavelength range that is indicated by area 1325. The combined contribution of the blue and green subpixels is indicated by the additional area 1330, the area of which is the same as that of the area 1325.

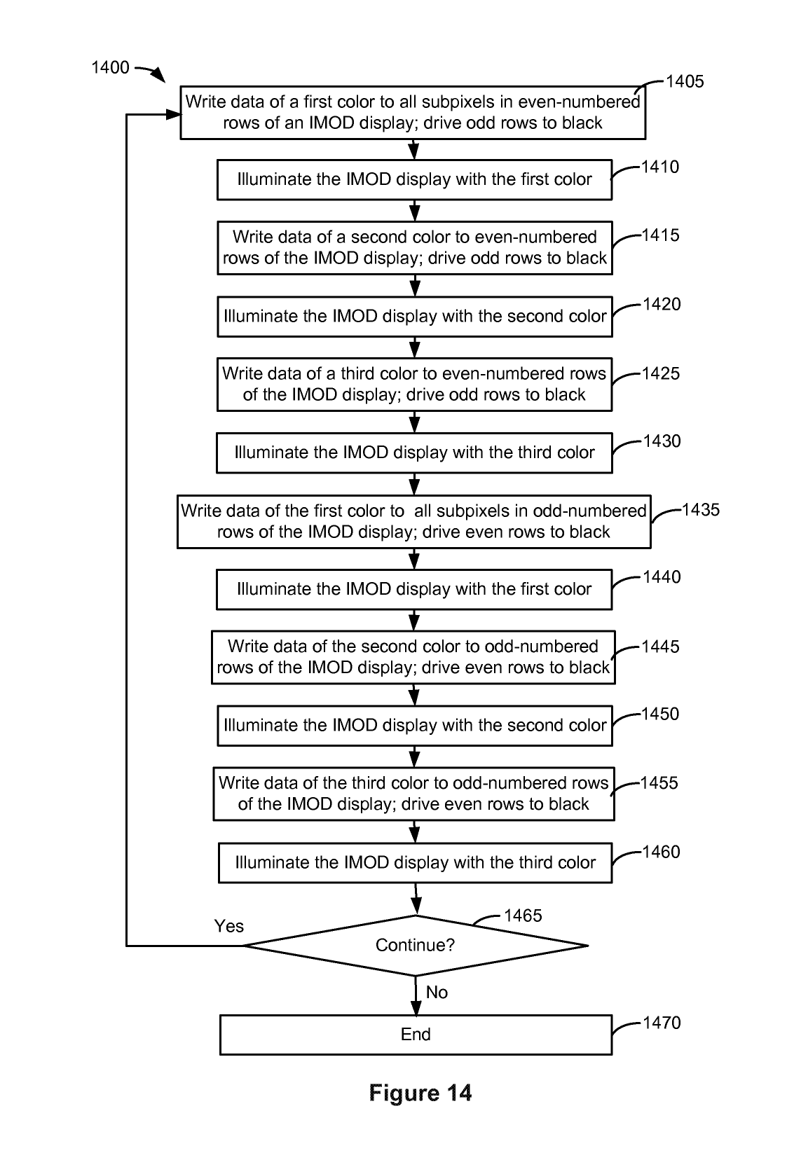

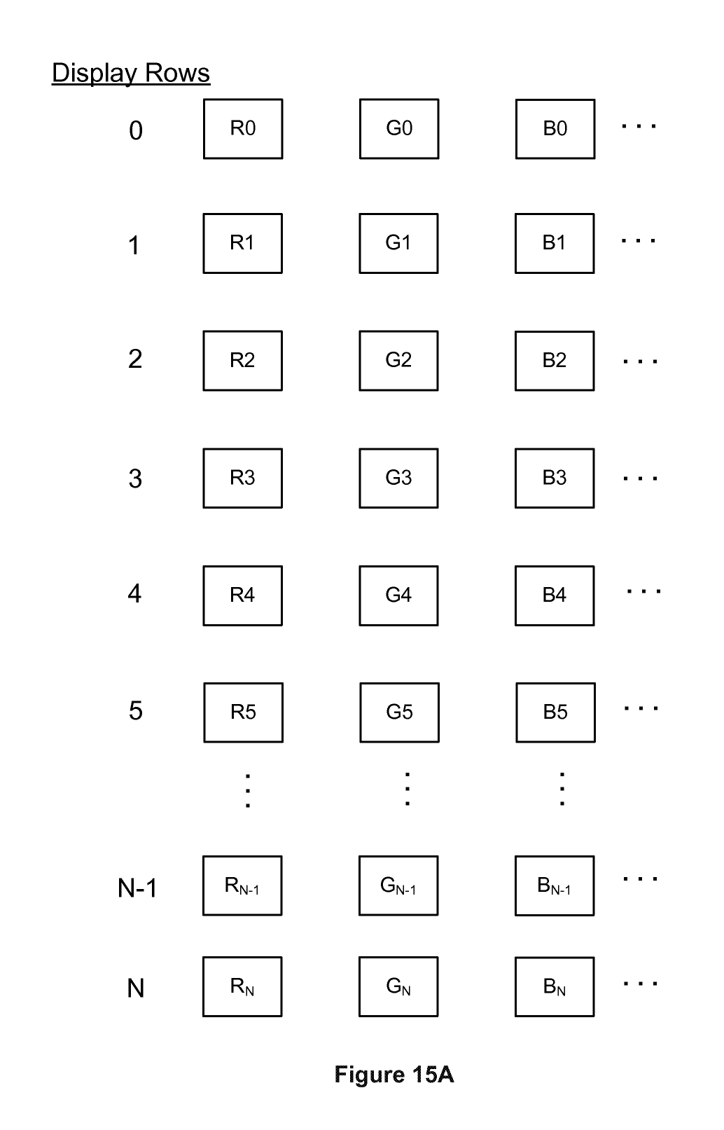

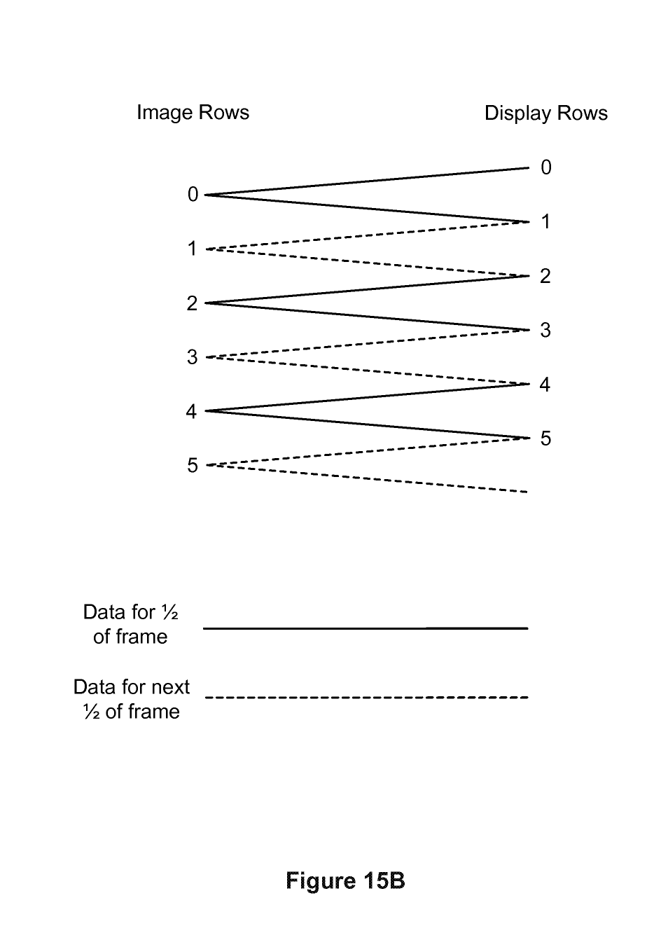

In some implementations, some but not all of the rows may be scanned and written with data of a certain color of a frame, followed by flashing a corresponding colored light, and the remaining rows can be scanned and written with data of the particular color of the frame later. Some examples will now be described with reference to FIGS. 14 through 15B. FIG. 14 shows an example of a flow diagram outlining processes for alternating between driving odd and even rows of interferometric modulators in a display. FIG. 15A shows an example of rows of interferometric modulators in a display.

In the example of FIG. 14, data for a first color is written to all subpixels in even-numbered rows of an array of interferometric modulation subpixels. (See block 1405 of FIG. 14.) In this example, rows to which color data are not being written (in this instance, the odd-numbered rows) are driven to black. Referring to FIG. 15A, for example, alternating rows 0, 2, 4 through N−1 are even-numbered rows and alternating rows 1, 3, 5 through N are odd-numbered rows. In this example, each “row” includes red, green and blue subpixels. However, the orientation of FIG. 15A is only an example. In other examples, a drawing of a subpixel array may be oriented such that each row includes a single subpixel color. Only a portion of the subpixels in the array is shown: as indicated by the ellipses, there are additional rows and columns of subpixels in the array that are not depicted in FIG. 15A. In block 1405 of FIG. 14, red data are written to all subpixels in alternating rows 0, 2, 4 through N−1, while all subpixels in alternating rows 1, 3, 5 through N are driven to black. The entire subpixel array is then illuminated with red light. (See block 1410.)

In block 1415, data for a second color (which is green in this example) are written to all subpixels in alternating rows 0, 2, 4 through N-1, while all subpixels in alternating rows 1, 3, 5 through N are driven to black. The entire subpixel array is then illuminated with green light. (See block 1420.) Then, data for a third color, which is blue in this example, are written to all subpixels in alternating rows 0, 2, 4 through N−1, while all subpixels in alternating rows 1, 3, 5 through N are driven to black. (See block 1425.) The entire subpixel array is then illuminated with blue light. (See block 1430.)

After the operation of block 1430, only half a frame of image data has been written to the subpixel array. Therefore, in block 1435, red data are written to all subpixels in odd-numbered rows (alternating rows 1, 3, 5 through N in this example), while all subpixels in even-numbered rows (alternating rows 0, 2, 4 through N−1 in this example) are driven to black. The entire subpixel array is then illuminated with red light. (See block 1440.)

In block 1445, data for a second color, which is green in this example, are written to all subpixels in alternating rows 1, 3, 5 through N, while all subpixels in alternating rows 0, 2, 4 through N−1 are driven to black. The entire subpixel array is then illuminated with green light. (See block 1450.) Then, data for a third color, which is blue in this example, are written to all subpixels in alternating rows 1, 3, 5 through N, while all subpixels in alternating rows 0, 2, 4 through N−1 are driven to black. (See block 1455.) The entire subpixel array is then illuminated with blue light. (See block 1460.) In block 1465, it is determined whether to continue controlling the display according to method 1400.

FIG. 15B shows an example of a diagram that depicts how to alternate between driving odd and even rows of interferometric modulators in a display without driving rows to black. In this implementation, when the first half of a frame of image data is being written, data from a single row of image data are written to two adjacent rows of the subpixel array. In this example, the data from even-numbered image rows are written first, but in other examples the data from odd-numbered image rows may be written first.

Here, data for a first color (e.g., red data) from row 0 of the image data may first be written to all subpixels in rows 0 and 1 of the display. At the same time, red data from row 2 of the image data may be written to all subpixels in rows 2 and 3 of the display, while red data from row 4 of the image data may be written to all subpixels in rows 4 and 5 of the display, etc., until all subpixel rows have been addressed. None of the subpixel rows are driven to black in this example. The display may then be illuminated by red light.

Data for a second color (e.g., green data) from even-numbered rows of the image data may then be written to all subpixels of the display. Green data from row 0 of the image may be written to all subpixels in rows 0 and 1 of the display, while green data from row 2 of the image data may be written to all subpixels in rows 2 and 3 of the display, and so on. None of the subpixel rows are driven to black in this example. The display may then be illuminated by green light.

In the same manner, data for a third color (e.g., blue data) from even-numbered rows of the image data may then be written to all subpixels of the display. The display may then be illuminated by blue light.

At this stage, half a frame of image data has been written to the display. To write the next half of the frame, red data from row 1 of the image may first be written to all subpixels in rows 1 and 2 of the display, while red data from row 3 of the image may be written to all subpixels in rows 3 and 4 of the display, etc., until all subpixel rows have been addressed. None of the subpixel rows are driven to black in this example. The display may then be illuminated by red light. In the same manner, green data from odd-numbered rows of the image may then be written to all subpixels of the display. The display may then be illuminated by green light. Blue data from odd-numbered rows of the image may then be written to adjacent subpixel rows of the display. The display may then be illuminated by blue light. At this time, an entire data frame will have been written.

Some such odd/even implementations have the advantage of being able to increase the overall time frame for writing a frame without causing noticeable flicker. In general, the shorter the overall frame time, the less chance of noticeable flicker. The time for writing an image data frame and illuminating the display should be kept below the flicker threshold T_{flicker}, beyond which a typical observer will detect flicker. T_{flicker} is a function of various factors, such as display resolution, subpixel size, the distance between an observer and the display, etc. There is also a subjective aspect to flicker perception.

For example, suppose that a “scrolling black” implementation (e.g., an implementation described above with reference to FIGS. 9 and 10A-B) had a frame time of 25 ms. An odd/even implementation might have a frame time of 40 ms (20 ms for the even rows and 20 ms for the odd rows), yet may have even less noticeable flicker than the scrolling black implementation. For a 40 ms frame time with the odd/even implementation, an observer's flicker perception may be similar to that for a frame having a 20 ms frame time. This is made possible by high display resolution: the spatial resolution of a high-resolution display can suppress flicker. The odd and even lines can dither each other in, so that odd/even methods implemented in a high-resolution display may have the same flicker perception as much shorter frames.

The subpixel size and spacing of the display affects T_{flicker}. For a given display size, having smaller subpixels means there are more rows of subpixels. Having more rows of subpixels will generally mean a relatively longer time for addressing all of the rows. A longer addressing time tends to make the frame time longer and having longer frame times tends to cause flicker. However, having relatively smaller subpixels can help to avoid artifacts due to spatial dithering. Accordingly, having higher resolution results in relatively fewer spatial artifacts, but more temporal artifacts (flicker). If a display is viewed at a distance of approximately 1.5 feet to 2 feet, a display line spacing on the order of 40 to 60 microns should provide sufficiently high resolution for the 40 ms frame time with the odd/even implementation in the foregoing example. A display line spacing in the low tens of microns, e.g., less than 50 microns, would further reduce the chance of perceptible flicker for this example.

Having a longer frame time allows for the possibility of increasing the overall time of flashing the colored light, which increases the brightness of the display. The available time to address a display is T_{address}=Nₗᵢₙₑₛ*line time, where line time is the time to write data to a single row and Nₗᵢₙₑₛ is the number of lines to which data will be written in the display. In some implementations, the front light flashing time can be computed by: T_{flashing}_{_{—}}ₜᵢₘₑ=T_{flicker}−T_{address}. If there are 3 colored lights to flash sequentially, the flashing time of each colored light can be computed by dividing T_{flashing}_{_{—}}ₜᵢₘₑ by 3.

For example, suppose that a “scrolling black” implementation had a frame time of 21 ms, with 18 ms for writing color data (6 ms per color) and 3 ms for flashing colored light from the front light (1 ms per color). An odd/even implementation might have a frame time of 42 ms (21 ms for the even rows and 21 ms for the odd rows). If the odd/even implementation took 18 ms for writing color data, the remaining 24 ms could be used for flashing colored light from the front light (4 ms for each color during both the odd phase and the even phase). However, a display being operated according to an odd/even implementation would generally still be dimmer in bright ambient light conditions than the display when being operated in a full reflective mode, such as the one described above with reference to FIGS. 11 and 12.

Alternatively, one can take advantage of the longer frame time to lower power consumption. Power usage is proportional to the flash time: if the flash time is not increased when the frame time is increased, less power will be consumed. The settings for specific implementations may seek to optimize power consumption and color saturation/gamut.

Other variations to the odd/even implementations may involve writing data to every third row, every fourth row, etc., and then flashing a corresponding colored light. Still other variations may involve adjusting the flashing time of colored lights after different sets of rows are scanned. For example, in some implementations, even rows may be illuminated for a first time whereas odd rows may be illuminated for a second time. The first time may be longer or shorter than the second time.

In alternative implementations, data of two colors (e.g., red and blue because their spectral responses are sufficiently separated) can be written first and then the corresponding colored lights (e.g., red light and blue light) may be flashed together. Referring again to FIG. 13, it may be observed that there is very little overlap between curve 1305 (the spectral response for blue subpixels in this example) and curve 1315 (the spectral response for red subpixels in this example). Because of the lack of overlap between the spectral responses for red and blue subpixels, the red light will not substantially affect the blue subpixels and vice versa.

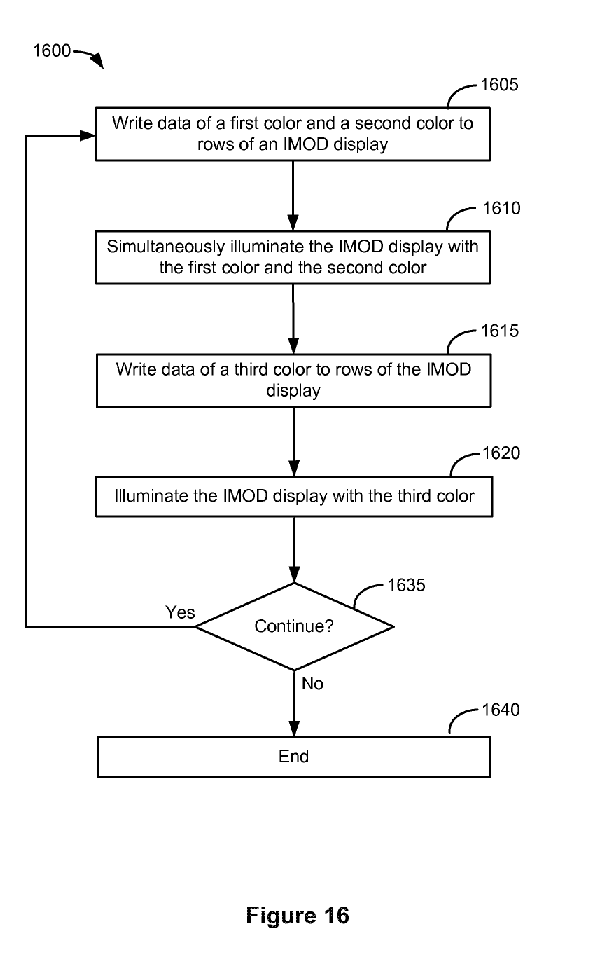

FIG. 16 shows an example of a flow diagram outlining processes for simultaneously writing more than one color to rows of subpixels in a display. In the current example, the display is an IMOD display. In block 1605, data for a first color and a second color are written to corresponding subpixels in the display. For example, red subpixels may be driven with red data only. Blue subpixels may be driven with blue data only. Green subpixels may be driven to black. Then, the display may be simultaneously illuminated with red and blue light. (See block 1610.)

Green data may then be written to green subpixels of the display, while red and blue subpixels are driven to black. (See block 1615.) The display may then be illuminated with green light. (See block 1620.) At this time, a frame of data has been written. In block 1635, it is determined whether to write another frame or to change the operational mode.

Such methods may be used in various ways. If so desired, these methods could be used to reduce the field time and therefore the frame time. By writing data and illuminating the display twice within a frame, instead of writing data and illuminating the display three times as in some of the above-described methods, the frame length could be reduced by approximately ⅓ if the writing time and flashing time are held substantially constant. For example, if a “scroll to black” implementation had a frame length of 18 ms, method 1600 could reduce the frame length to 12 ms. Alternatively, or additionally, these methods may be used to increase the overall amount of time available for illuminating the display. If the same frame length is used (e.g., 18 ms), an additional ⅓ of the frame (6 ms) becomes available for illumination. For example, if the overall “flash time” available in a “scroll to black” implementation is 3 ms per frame, which may be divided equally between the three colors (i.e., 1 ms per color), the illumination time of method 1600 could be increased to 9 ms if so desired. The red and blue lights could be flashed for 4.5 ms and the green light could be flashed for 4.5 ms in one example. Note that the available “flash time” may not be divided equally between the colors. Different lengths of time could be used for the different colors, e.g., 5 ms for red and blue and 4 ms for green.

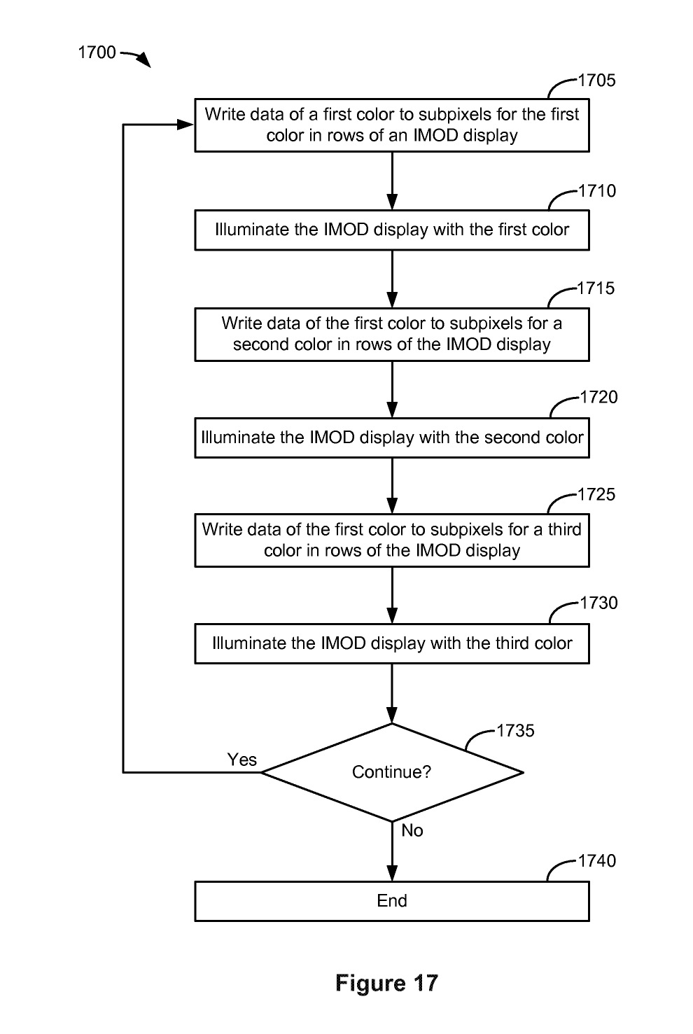

FIG. 17 shows an example of a flow diagram outlining processes for sequentially writing data for a single color to all interferometric modulators in a display. In this example, green data are written to subpixels associated with each color sequentially, each followed by flashing of a corresponding colored light. In block 1705, the green subpixels are written with green data, followed by flashing of a green light (block 1710). Then, the red subpixels are written with green data (block 1715), followed by flashing of a red light (block 1720). Subsequently, the blue pixels can be scanned and written with green data (block 1725), followed by flashing of a blue light (block 1730). This process can cause the display to generate a pale green color.

At this time, a frame of image data has been written to the display. It may then be determined (block 1735) whether to revert to block 1705 and write another frame or to change the operational mode of the display.

FIG. 18 shows an example of a graph of color gamut versus brightness of ambient light for different types of displays. The brightness of ambient light is indicated on the horizontal axis and color gamut is indicated on the vertical axis. Curve 1805 indicates the response of a typical LCD display. Curve 1810 indicates the response of a conventional IMOD display, whereas curve 1815 shows the response of an IMOD display being operated according to some methods described herein. Region 1820 indicates levels of ambient light brightness for which use of a front light is appropriate for an IMOD display, whereas region 1830 indicates levels of ambient light brightness for which a front light would generally be powered off.

It may be observed from FIG. 18 that under conditions of low ambient light, the color gamut provided by a conventional IMOD display is substantially lower than that of a typical LCD display. However, the color gamut provided by an IMOD display being operated according to some methods described herein approaches that of a typical LCD display. Under bright ambient light conditions, either type of IMOD display provides much better color gamut than a typical LCD display.

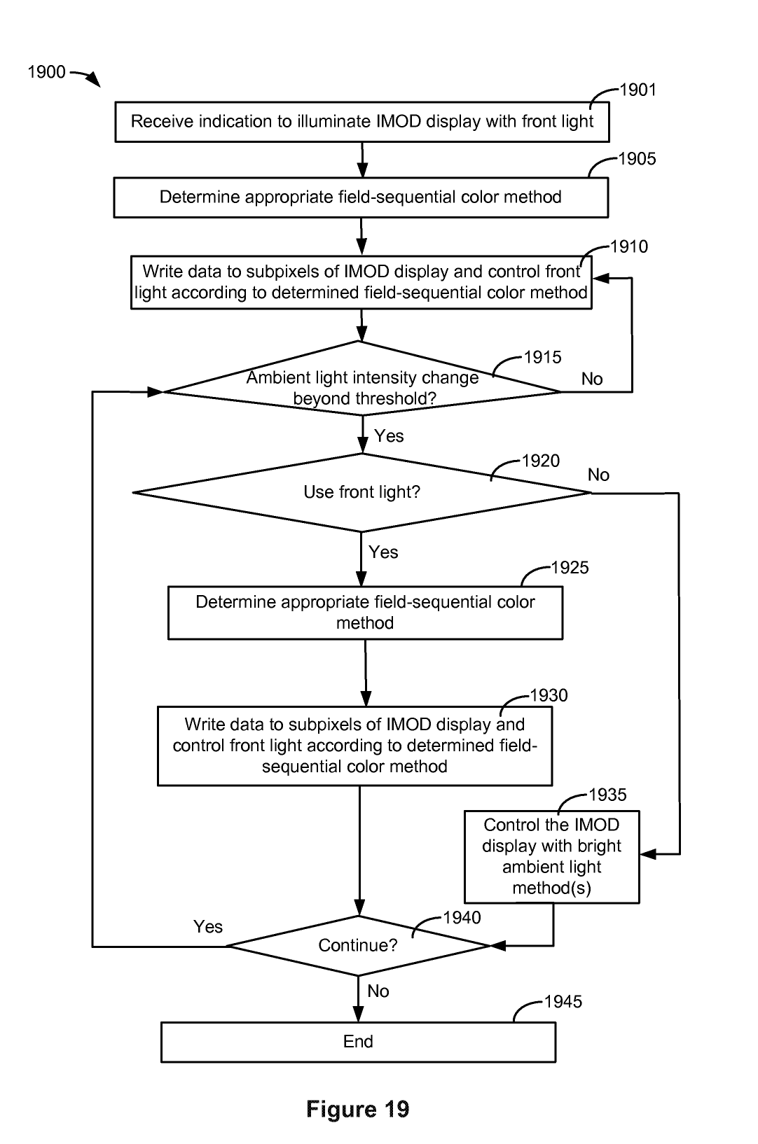

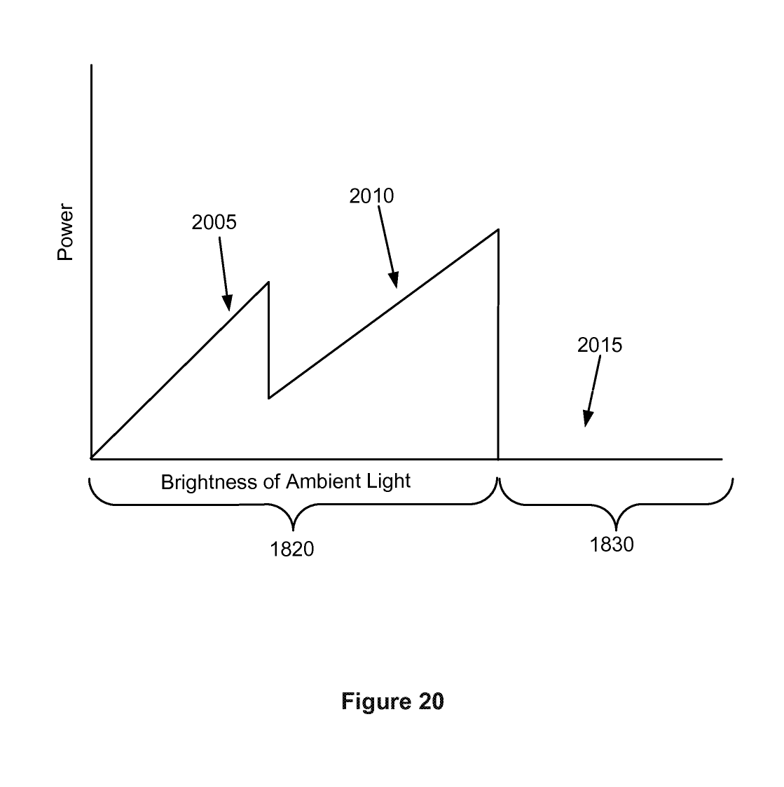

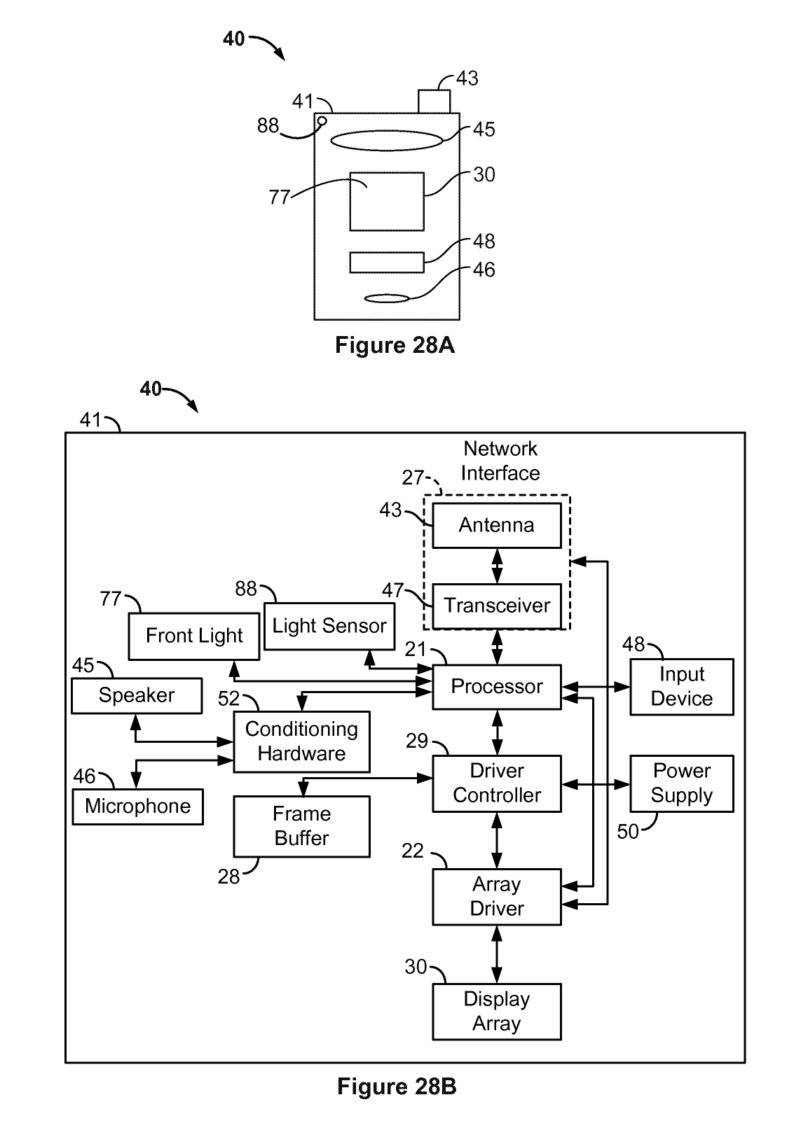

FIG. 19 shows an example of a flow diagram outlining processes for controlling a display according to the brightness of ambient light. FIG. 20 shows an example of a graph of data that may be referenced in a process such as that outlined in FIG. 19. In this example, the display is an IMOD display. In block 1901 of FIG. 19, an IMOD display device receives an indication that the display should be illuminated with a front light. In some implementations, the indication may be according to user input. However, in this example the indication is provided according to a level of ambient light brightness detected by an ambient light sensor, e.g., an ambient light sensor described below with reference to FIGS. 28A and 28B.

Some display devices may be configured to use two or more different field-sequential color methods for controlling the display. In the example shown in FIG. 20, two different field-sequential color methods may be used to control the display when a front light is in operation. A first field-sequential color method 2005 is used under the lowest ambient light conditions, whereas a second field-sequential color method 2010 is used if the ambient light is somewhat brighter. For example, in some implementations, the first field-sequential color method 2005 may be a “scroll to black” or “flash to black” method such as described above with reference to FIGS. 9 and 10. The second field-sequential color method 2010 may be another method described herein, such as method 1100 (see FIG. 11), method 1400 (see FIG. 14) or method 1600 (see FIG. 16). In this example, both of the methods 2005 and 2010 involve increasing the power level under conditions of relatively brighter ambient light.

Method 2015 may be used when the ambient light is sufficiently bright that illumination via a front light is not beneficial. In some implementations, a “taper off” method may be used to transition between method 2010 and powering off the front light. For example, the front light may be powered off over a few hundred ms, half a second or some other period of time.

Referring again to FIG. 19, an appropriate field-sequential color method is selected in block 1905. In this example, a controller (e.g., implemented by a processor) determines an appropriate field-sequential color method according to the level of ambient light brightness detected by the ambient light sensor. In block 1910, data are written to subpixels of the display and a front light is controlled according to the field-sequential color method determined in block 1905.

As the display device is being operated, the ambient light intensity may be monitored. In block 1915, for example, it is determined whether the ambient light intensity has changed beyond a predetermined threshold. Small changes in ambient light may indicate that the same field-sequential color method will be used to control the display, but with a higher or low level of power applied (see FIG. 20). Larger changes may require an evaluation of whether the front light should still be used (block 1920). If not, the display may be controlled in a manner appropriate for bright ambient light conditions (block 1935), e.g., as a conventional IMOD display is controlled. Then method 1900 may transition to block 1940.

If it is determined in block 1920 that the front light should still be used, it may be determined whether or not the same field-sequential color method will be used to control the display (block 1925). In block 1930, the display will be controlled according to the field-sequential color method determined in block 1925. In block 1940, it is determined whether to continue in the current operational mode, e.g., as described elsewhere herein. If so, the power level may be adjusted according to ambient light intensity (see FIG. 20). The ambient light intensity may continue to be monitored (block 1915).

Some implementations described herein can produce a black and white display suitable for displaying text. For example, a black and white display may be produced using a magenta light (e.g., made by adding a magenta filter to white light generated by a light source) to illuminate green interferometric subpixels, or vice versa.

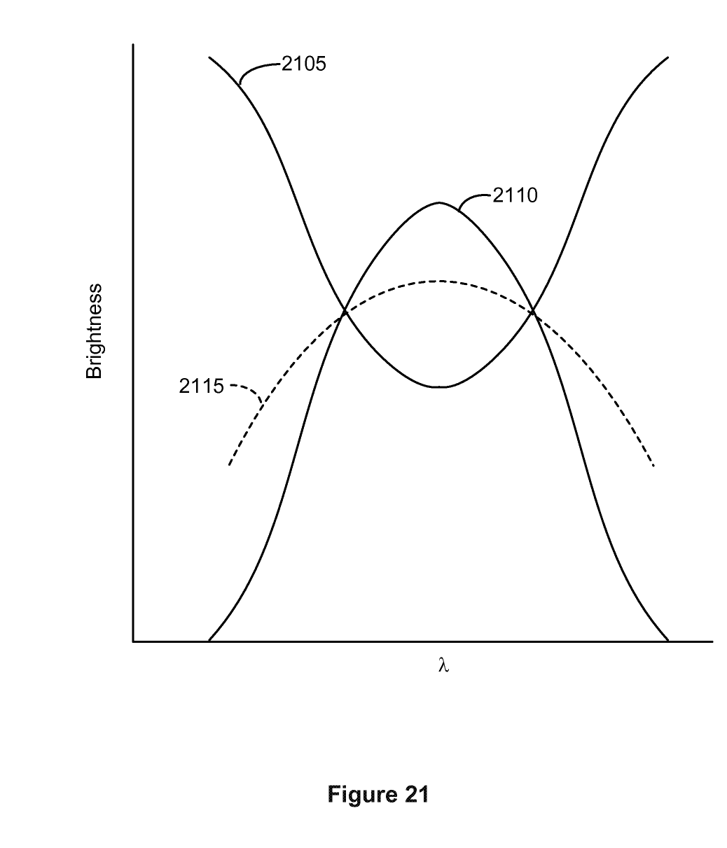

FIG. 21 shows an example of a graph of the spectral response of a green interferometric subpixel being illuminated by a magenta light. The magenta filter applied to produce the magenta light is indicated by curve 2105. The spectral response of the green interferometric subpixel is indicated by curve 2110. The resulting spectral response is indicated by curve 2115. It may be observed that curve 2115 is broader and flatter than curve 2110, indicating less light produced near the peak green wavelengths of curve 2110 and more light produced towards the red and blue ends of the visible spectrum. Accordingly, curve 2115 indicates a light produced by a green interferometric subpixel that may appear white to an observer.

In some implementations, the same display device can provide a color display in a dark environment (e.g., indoors) and a black and white (monochrome) display in a bright environment (e.g., outdoors). Alternatively, in some such implementations, all of the interferometric subpixels in the display could be configured to produce substantially the same spectral response. For example, all of the interferometric subpixels in the display could be configured as green subpixels. Such a display would not provide a multi-color display.

Applying the foregoing field-sequential color methods to reflective displays can provide a number of advantages. For example, when a reflective display is used in low ambient light conditions, the foregoing field-sequential color methods can increase the color gamut of the display. Some implementations provide increased brightness and/or color saturation.

However, providing grayscale for such displays has proven to be challenging. One might imagine that known temporal grayscale methods could be combined with the above-mentioned field-sequential color methods in a reflective display. However, it is not apparent how such methods could be combined. With temporal grayscale methods, the gray level depends on the length of time the image is displayed. For example, to have two bits of grayscale via a temporal grayscale method, a display is addressed twice during a single frame. The MSB is used to drive the display twice as long as the LSB. Such methods do not seem to be compatible with the above-described field-sequential color methods, which involve pulsing a colored light source briefly after image data for a corresponding color field are written.

Accordingly, novel grayscale methods are disclosed herein. Some such methods exploit the overlapping spectral responses of reflective subpixels. In the example described above with reference to FIG. 13, the spectral response of the green subpixels substantially overlaps with the spectral response of the blue subpixels and the spectral response of the red subpixels. However, it may be observed that there is very little overlap between curve 1305 (the spectral response for blue subpixels in this example) and curve 1315 (the spectral response for red subpixels in this example). Because of the lack of overlap between the spectral responses for red and blue subpixels, the red light will not substantially affect the blue subpixels and vice versa.

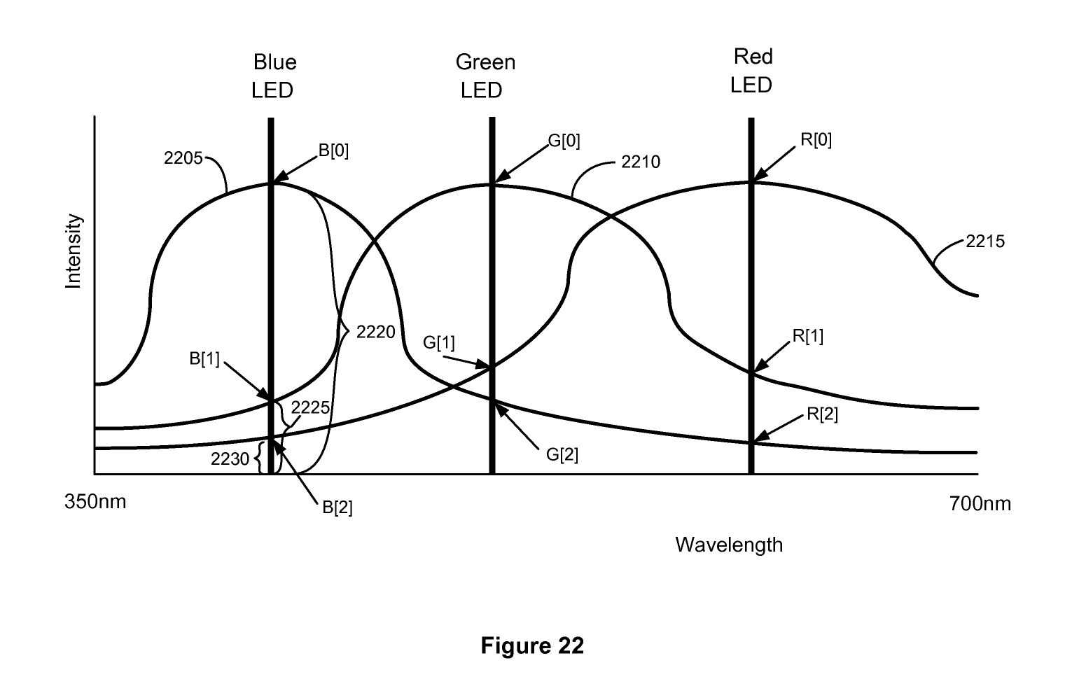

However, in some other implementations, there may be a more substantial overlap between the spectral responses for red and blue subpixels. One such implementation will now be described with reference to FIG. 22.

FIG. 22 shows an example of a graph of the spectral response of three reflective subpixels, each of which has an intensity peak that corresponds with a different color. In this example, the curve 2205 corresponds to the spectral response of blue subpixels, the curve 2210 corresponds to the spectral response of green subpixels and the curve 2015 corresponds to the spectral response of red subpixels in the subpixel array. In this implementation, the spectral response of the green subpixels substantially overlaps with the spectral response of the blue subpixels and the spectral response of the red subpixels. Moreover, the spectral response of the blue subpixels substantially overlaps not only with that of the green subpixels, but also with that of the red subpixels. Similarly, the spectral response of the red subpixels substantially overlaps not only with that of the green subpixels, but also with that of the blue subpixels.

FIG. 22 also provides examples of wavelength ranges that correspond with blue, green and red light sources (LEDs in this example) that may be used to illuminate the reflective display. In this example, the wavelength ranges of the blue, green and red LEDs correspond with intensity peaks for the spectral responses of the blue, green and red subpixels. At the wavelengths corresponding to the blue LED, the blue subpixels contribute an intensity 2220 in the blue wavelength range. In addition to the contribution of the blue subpixels, the green subpixels contribute an intensity 2225 in this wavelength range. The red subpixels contribute an intensity 2230.

If all three subpixels were configured to reflect light when the blue LED is illuminated, the combined intensity would be the sum of intensities 2220, 2225 and 2230. However, if the red subpixel were in a black state while the green and blue subpixels were configured to reflect light, the combined intensity would be the sum of intensities 2220 and 2225. Similarly, if the green subpixel were in a black state while the red and blue subpixels were configured to reflect light, the combined intensity would be the sum of intensities 2220 and 2230. Accordingly, the amount of brightness for each color may be modulated according to the state of each subpixel.

Some implementations described herein use colors other than the field color to produce grayscale. In this three-bit example, the field color may correspond to the most significant bit (MSB) and the other colors may correspond to the other two bits. For the blue field, the blue subpixel may be driven according to the MSB (B[0]), the green subpixel may be driven according to the next bit (B[1]) and the red subpixel may be driven according to the least significant bit (LSB) B[2].

Although the state of each reflective subpixel corresponds with a bit in this example, the contributions of each subpixel will not generally correspond with powers of two. Instead, the contributions of each subpixel will depend on the spectral response of each subpixel and the extent of overlap with the spectral response of the other subpixels of the display. For example, by comparing the intensity corresponding to the LSB for green (G[2]) to the intensities of the LSB for blue (B[2]) and red (R[2]), one can see that the intensity of G[2] is substantially greater than that of B[2] or R[2]. This means that in this example, when the blue subpixel is configured to reflect light it will contribute more intensity to the green field than a reflective red subpixel will contribute to the blue field.

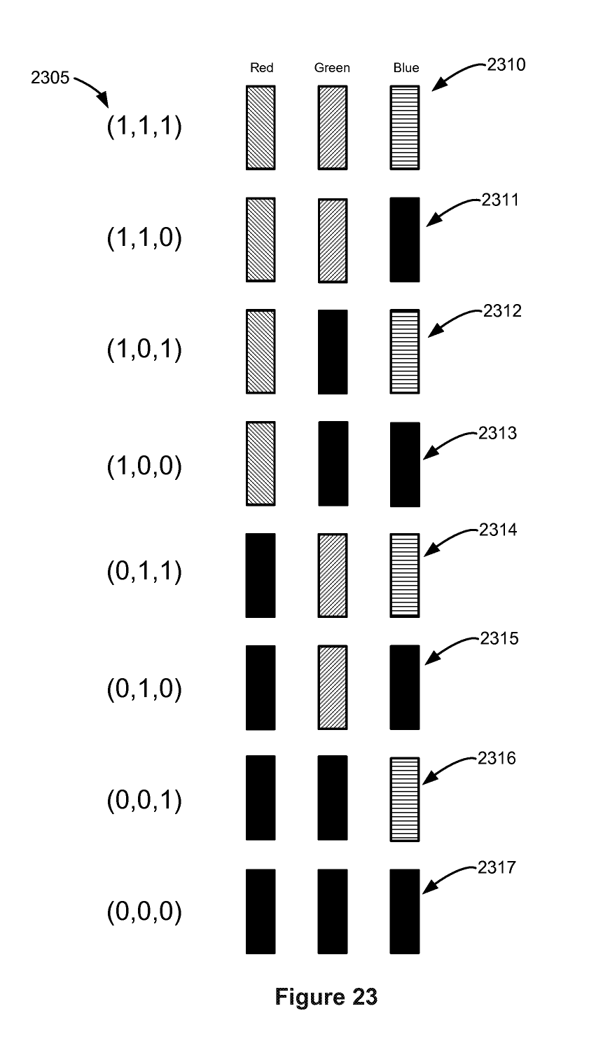

FIG. 23 shows an example of reflective subpixel configurations corresponding to three bits and eight grayscale levels. In such implementations, eight different brightness levels may be obtained for each field color. In this example, the red field will be considered. Each three-bit group 2305 corresponds with a subpixel state 2310. Because FIG. 23 involves the red field, each three-bit group 2305 indicates (R[0],R[1],R[2]), the MSB, next bit and LSB for red. In some implementations, this three-bit group 2305 may correspond with the intensity values for R[0], R[1] and R[2] that are indicated in FIG. 22.

Here, the three-bit group (1,1,1) corresponds with a subpixel state 2310 in which the red, green and blue subpixels are all configured to reflect light in the red field. Therefore, the subpixel state 2310 corresponds with maximum brightness for red color. The three-bit group (1,1,0) corresponds with a subpixel state 2311 in which only the red and green subpixels are configured to reflect light in the red field. The blue subpixel is configured to be in the black state and therefore does not make a significant intensity contribution in the red field. However, because the blue subpixel corresponds with the LSB R[2], if the intensity contribution is similar to that shown in FIG. 22 the subpixel state 2311 for the three-bit group (1,1,0) may not be substantially less bright than the subpixel state 2310 corresponding to the three-bit group (1,1,1).

The three-bit group (1,0,1) corresponds with a subpixel state 2312 in which only the red and blue subpixels are configured to reflect light in the red field. The green subpixel is configured to be in the black state and therefore does not make a significant intensity contribution in the red field. Because the green subpixel corresponds with R[1], this subpixel state 2312 may be substantially less bright than the subpixel state 2310 corresponding to the three-bit groups (1,1,1). For example, if the intensity contributions of the blue and green subpixels in the red field are similar to those shown in FIG. 22, the green subpixels may be contributing more than three times the intensity than the blue subpixels in the red field.

However, intensities corresponding to the three-bit groups (1,1,0) and (1,0,1) may vary substantially from field to field. For example, if the intensity contributions of the blue and red subpixels in the green field also are similar to those shown in FIG. 22, the difference between the intensities corresponding to G[1] and G[2] may be substantially less than the difference between the intensities corresponding to R[1] and R[2]. Therefore, one would expect less of a difference between the intensities corresponding to the three-bit groups (1,1,0) and (1,0,1) in the green field as compared to the difference between the intensities for the three-bit groups (1,1,0) and (1,0,1) in the red field.

Referring again to FIG. 23, the relative intensities of the subpixel states 2310-2317 corresponding to the three-bit groups 2305 continue to decrease in a downward direction. As noted above, the changes in brightness between the three-bit groups 2305 may vary substantially and may differ according to the field color. For each field color, however, there may be a significant decrease in intensity between the subpixel state 2313 for the three-bit group (1,0,0) and the subpixel state 2314 for the three-bit group (0,1,1): for all field colors, having the MSB set to zero means having the corresponding colored subpixel driven to black. Here, for example, having the MSB set to zero means having the red subpixel driven to black during the red field. The lowest intensity levels correspond to the subpixel state 2316 for the three-bit group (0,0,1), in which only the blue subpixel is reflecting light during the red field, and the subpixel state 2317 for the three-bit group (0,0,0), in which all subpixels are driven to black during the red field.

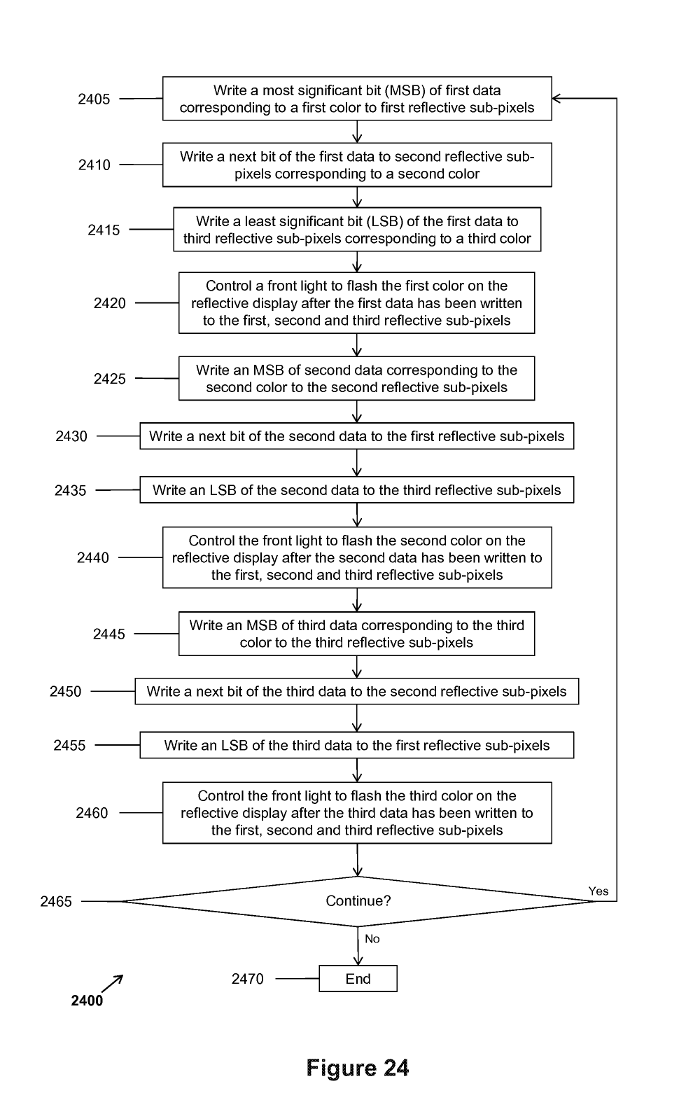

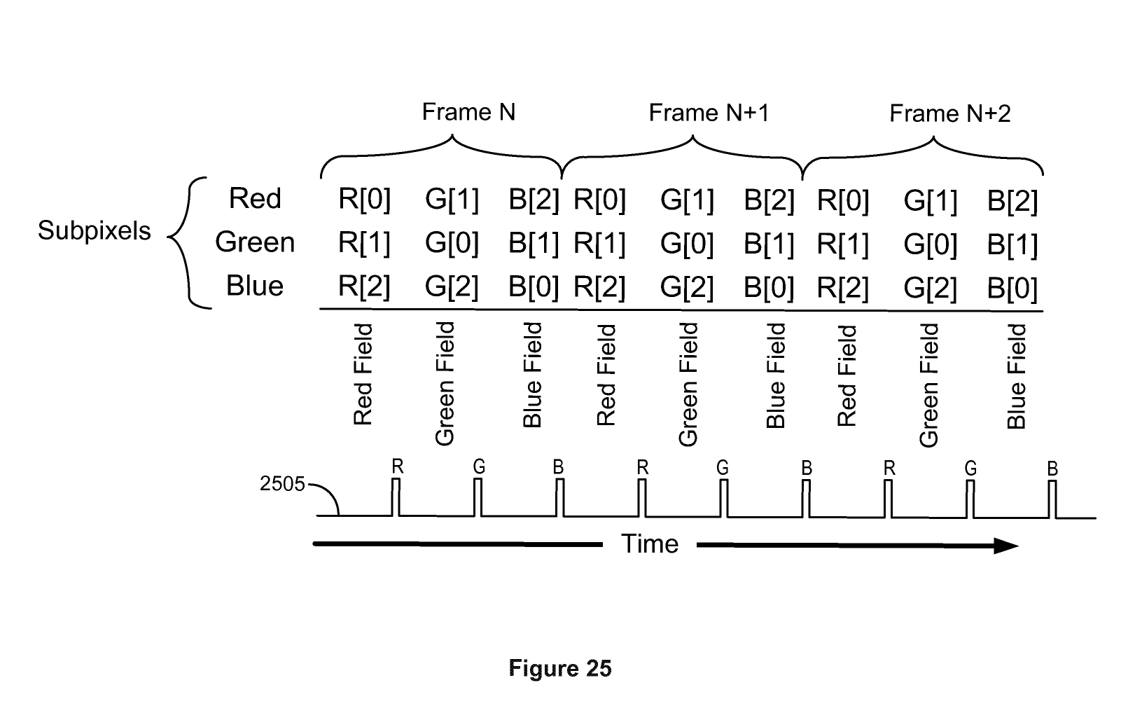

FIG. 24 shows an example of a flow diagram outlining a process for controlling a reflective display according to a grayscale method for field-sequential color. FIG. 25 shows an example of controlling subpixels of a reflective display according to the process of FIG. 24.

The process 2400 of FIG. 24 may, for example, be implemented in a reflective display. The reflective display may, in some implementations, be a component of a portable display device such as the display device 40 that is described below with reference to FIGS. 28A and 28B.

The reflective display may include an illumination system, reflective subpixels and a control system. The illumination system may include a front light that is configured to illuminate the reflective display with a first color, a second color and a third color. The reflective display may include a plurality of first reflective sub-pixels corresponding to the first color, a plurality of second reflective sub-pixels corresponding to the second color and a plurality of third reflective sub-pixels corresponding to the third color. The control system may, for example, include at least one of a general purpose single- or multi-chip processor, a digital signal processor (DSP), an application specific integrated circuit (ASIC), a field programmable gate array (FPGA) or other programmable logic device, discrete gate or transistor logic, discrete hardware components, or combinations thereof.

Accordingly, in some implementations the blocks of the process 2400 may be implemented, at least in part, by such a control system. In some implementations, the process 2400 may be implemented, at least in part, by software encoded in a non-transitory medium. The software may include instructions for controlling a reflective display to perform the process 2400 or other processes described herein.

In block 2405, an MSB of first data corresponding to the first color may be written to at least some of the first reflective subpixels. A next bit of the first data may be written to the second reflective sub-pixels (block 2410) and an LSB of the first data may be written to at least some of the third reflective sub-pixels (block 2415). In some implementations, the control system may be configured to assign bit values according to grayscale levels that correspond with values of the MSB, the next bit and the LSB. The control system may be configured to receive grayscale level data and to determine the bit values according to the grayscale level data. For example, the control system may be configured to determine the bit values by referencing a data structure that has grayscale levels and corresponding values of the MSB, the next bit and the LSB stored therein.

The front light may be controlled to flash the first color on the reflective display after the first data have been written to the first, second and third reflective sub-pixels (block 2420). The blocks 2405 through 2420 correspond to a first color field of a frame of image data in this example.

Referring to FIG. 25, the red field of frame N provides one example of the blocks 2405 through 2420. MSB R[0] is written to the red subpixels of a reflective display, while next bit R[1] is written to the green subpixels and LSB R[2] is written to the blue subpixels. In this example, R[0], R[1] and R[2] are written at substantially the same time. Element 2505 indicates when the reflective display is illuminated and by what color of light. After R[0], R[1] and R[2] are written, the reflective display is illuminated with red light.

Returning to FIG. 24, in block 2425 an MSB of second data corresponding to the second color may be written to at least some of the second reflective subpixels. A next bit of the second data may be written to at least some of the first reflective sub-pixels (block 2430) and an LSB of the second data may be written to at least some of the third reflective sub-pixels (block 2435). The front light may be controlled to flash the second color on the reflective display after the second data have been written to the first, second and third reflective sub-pixels (block 2440). The blocks 2425 through 2440 correspond to a second color field in this example.

Referring again to FIG. 25, the green field of frame N provides an example of the blocks 2425 through 2440. MSB G[0] is written to the green subpixels of a reflective display, while next bit G[1] is written to the red subpixels and LSB G[2] is written to the blue subpixels. After G[0], G[1] and G[2] are written, the reflective display is illuminated with green light.

Returning to FIG. 24, in block 2445 an MSB of third data corresponding to the third color may be written to at least some of the third reflective subpixels. A next bit of the third data may be written to at least some of the second reflective sub-pixels (block 2450) and an LSB of the third data may be written to at least some of the first reflective sub-pixels (block 2455). The front light may be controlled to flash the third color on the reflective display after the third data have been written to the first, second and third reflective sub-pixels (block 2460). The blocks 2445 through 2460 correspond to a third color field in this example.

In FIG. 25, the blue field of frame N provides an example of the blocks 2445 through 2460. MSB B[0] is written to the blue subpixels of a reflective display, while next bit B[1] is written to the green subpixels and LSB B[2] is written to the red subpixels. After B[0], B[1] and B[2] are written, the reflective display is illuminated with blue light.

Returning again to FIG. 24, in block 2465 it is determined whether to continue the process 2400. For example, the process 2400 may end (block 2470) if user input is received indicating that the reflective display will be switched off, if the reflective display enters a sleep mode, or for various other reasons. However, if the process 2400 will continue, the process may revert to the block 2405 and the first field of another frame of image data may be processed. One example is provided in FIG. 25, wherein the process continues from frame N to frame N+1. Additional frames N+2, etc., may subsequently be processed.

The foregoing example involves three-bit groups and eight grayscale levels. However, other implementations may involve more or fewer bits and brightness levels. Some such implementations are described below.

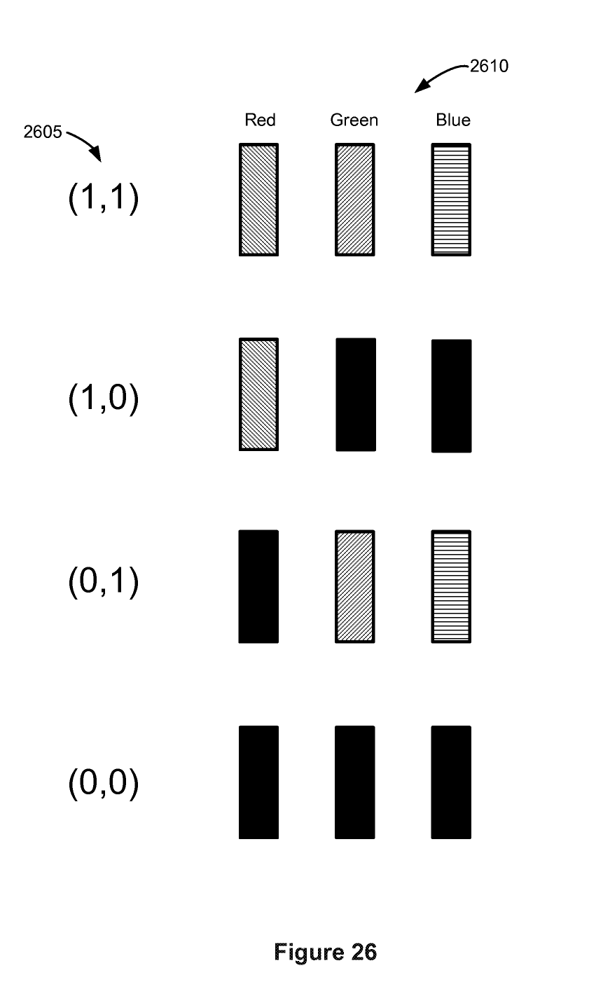

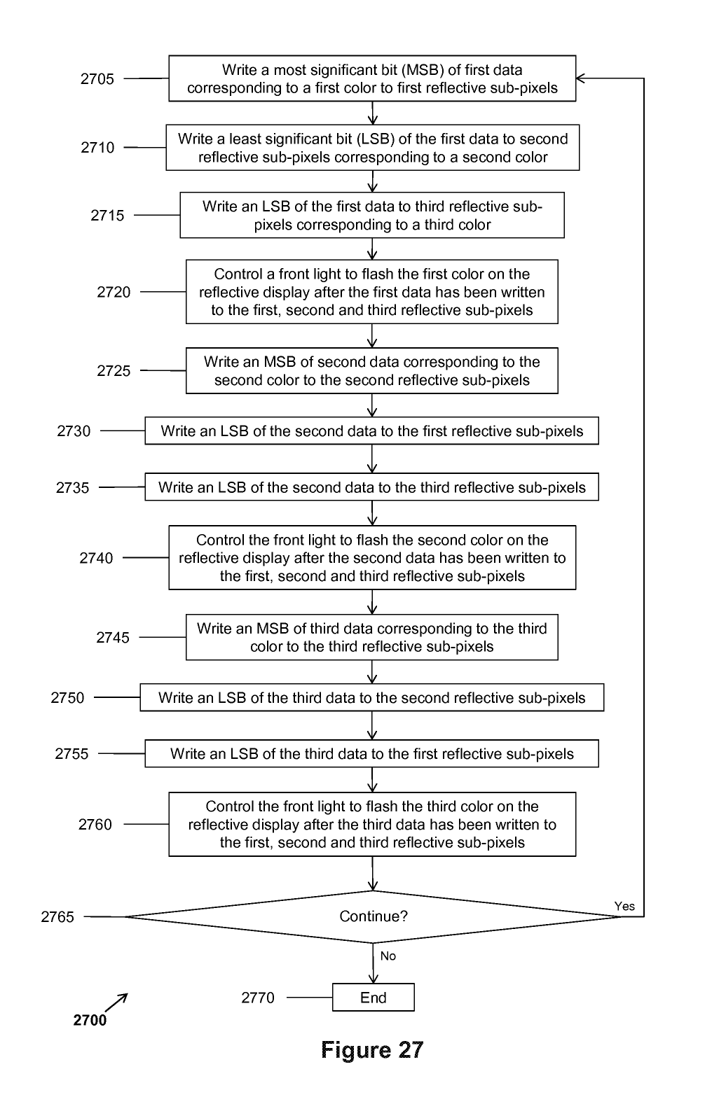

FIG. 26 shows an example of reflective subpixel configurations corresponding to two bits and four grayscale levels. FIG. 27 shows an example of a flow diagram outlining an alternative process for controlling a reflective display according to a grayscale method for field-sequential color.

Referring first to FIG. 26, each two-bit group 2605 corresponds with a subpixel state 2310. In this implementation, four different brightness levels may be obtained for each field color. Because FIG. 26 involves the red field, each two-bit group 2605 corresponds with a subpixel state 2310 of the red field.

Because only two bits are used to control three subpixel colors, subpixels having a color other than the field color are controlled according to the same bit in this example. Here, both the green subpixel and the blue subpixel are controlled according to the same bit (the LSB) when the field color is red. When the field color is green, both the red and the blue subpixels are controlled according to the LSB. When the field color is blue, the red and the green subpixels are controlled with the LSB.

Accordingly, the two-bit group (1,1) and the three-bit group (1,1,1) both correspond to the same subpixel state 2310. Similarly, the same subpixel state 2310 corresponds to the two-bit group (1,0) and the three-bit group (1,0,0). (See FIG. 23.) The subpixel state 2310 for the two-bit group (0,1) is the same as that for the three-bit group (0,1,1). Likewise, the two-bit group (0,0) and the three-bit group (0,0,0) both correspond to the same subpixel state 2310.

In alternative implementations, however, the subpixels may be grouped differently. In some such implementations, the subpixel corresponding to the field color (the red subpixel in this example) and one of the other subpixels may be controlled according to the MSB. For example, in the red field the red subpixel and the blue subpixel may both be controlled according to the MSB for red. In such implementations, the same subpixel state 2310 may correspond to the two-bit group (1,0) and the three-bit group (1,0,1). (See FIG. 23.) The subpixel state 2310 for the two-bit group (0,1) may be the same as that for the three-bit group (0,1,0).

The process 2700 of FIG. 27 may be implemented in a reflective display, e.g., by a control system of such a display. The reflective display may, for example, be a component of a portable display device such as the display device 40 that is described below with reference to FIGS. 28A and 28B. In some implementations, the process 2700 may be implemented, at least in part, by software encoded in a non-transitory medium.

In block 2705, an MSB of first data for a first color may be written to at least some first reflective sub-pixels corresponding to the first color. An LSB of the first data also may be written to at least some second reflective sub-pixels corresponding to a second color (block 2710) and to at least some third reflective sub-pixels corresponding to a third color (block 2715). An illumination system, which may include a front light, may be controlled to flash the first color on the reflective display after the first data have been written to the first, second and third reflective sub-pixels (block 2720). The blocks 2705 through 2720 correspond to a first color field for a frame of image data in this example.

An MSB of second data for the second color may then be written to at least some of the second reflective sub-pixels (block 2725). An LSB of the second data also may be written to at least some of the first reflective sub-pixels (block 2730) and to at least some of the third reflective sub-pixels (block 2735). The illumination system may be controlled to flash the second color on the reflective display after the second data have been written to the first, second and third reflective sub-pixels (block 2740). The blocks 2725 through 2740 correspond to a second color field for a frame of image data.

Subsequently, an MSB of third data for the third color may be written to at least some of the third reflective sub-pixels (block 2745). An LSB of the third data also may be written to at least some of the second reflective sub-pixels (block 2750) and to at least some of the first reflective sub-pixels (block 2755). The illumination system may be controlled to flash the third color on the reflective display after the third data have been written to the first, second and third reflective sub-pixels (block 2760). The blocks 2745 through 2760 correspond to a third color field for a frame of image data.

In block 2765 it is determined (e.g., by a control system of the display) whether to continue the process 2700. For example, the process 2700 may end (block 2770) if user input is received indicating that the reflective display will be switched off, if the reflective display enters a sleep mode, etc. However, if it is determined in the block 2765 that the process 2700 will continue, the process 2700 reverts to the block 2705 in this example. The first field of another frame of image data may be processed.

FIGS. 28A and 28B show examples of system block diagrams illustrating a display device that includes a plurality of interferometric modulators. The display device 40 can be, for example, a cellular or mobile telephone. However, the same components of the display device 40 or slight variations thereof are also illustrative of various types of display devices such as televisions, e-readers and portable media players.

The display device 40 includes a housing 41, a display 30, an antenna 43, a speaker 45, an input device 48, an ambient light sensor 88 and a microphone 46. The housing 41 can be formed from any of a variety of manufacturing processes, including injection molding, and vacuum forming. In addition, the housing 41 may be made from any of a variety of materials, including, but not limited to: plastic, metal, glass, rubber, and ceramic, or a combination thereof. The housing 41 can include removable portions (not shown) that may be interchanged with other removable portions of different color, or containing different logos, pictures, or symbols.

The display 30 may be any of a variety of displays, including a bi-stable or analog display, as described herein. The display 30 also can be configured to include a flat-panel display, such as plasma, EL, OLED, STN LCD, or TFT LCD, or a non-flat-panel display, such as a CRT or other tube device. In this example, the display 30 includes an interferometric modulator display, as described herein.

In this example, the display device 40 includes a front light 77. The front light 77 may provide light to the interferometric modulator display when there is insufficient ambient light. The front light 77 may include one or more light sources and light-turning features configured to direct light from the light source(s) to the interferometric modulator display. The front light 77 may also include a wave guide and/or reflective surfaces, e.g., to direct light from the light source(s) into the wave guide. In some implementations, the front light 77 may be configured to provide red, green, blue, yellow, cyan, magenta and/or other colors of light, e.g., as described herein. However, in other implementations the front light 77 may be configured to provide substantially white light.

The components of the display device 40 are schematically illustrated in FIG. 28B. The display device 40 includes a housing 41 and can include additional components at least partially enclosed therein. For example, the display device 40 includes a network interface 27 that includes an antenna 43 which is coupled to a transceiver 47. The transceiver 47 is connected to a processor 21, which is connected to conditioning hardware 52. The conditioning hardware 52 may be configured to condition a signal (e.g., filter a signal). The conditioning hardware 52 is connected to a speaker 45 and a microphone 46. The processor 21 is also connected to an input device 48 and a driver controller 29. The driver controller 29 is coupled to a frame buffer 28, and to an array driver 22, which in turn is coupled to a display array 30. A power supply 50 can provide power to all components as required by the particular display device 40 design.

In this example, the processor 21 is configured to control the front light 77. According to some implementations, the processor 21 is configured to control the front light 77 in accordance with one or more of the field-sequential color methods described herein. In some such implementations, the processor 21 is configured to control the front light 77 according to data from ambient light sensor 88. For example, the processor 21 may be configured to select one of the field-sequential color method described herein and to control the front light 77 based, at least in part, on the brightness of ambient light. Alternatively, or additionally, the processor 21 may be configured to select one of the field-sequential color methods described herein and/or to control the front light 77 based on user input. The processor 21, the driver controller 29 and/or other devices may control the interferometric modulator display in accordance with one or more of the field-sequential color methods and/or grayscale methods described herein.

The network interface 27 includes the antenna 43 and the transceiver 47 so that the display device 40 can communicate with one or more devices over a network. The network interface 27 also may have some processing capabilities to relieve, e.g., data processing requirements of the processor 21. The antenna 43 can transmit and receive signals. In some implementations, the antenna 43 transmits and receives RF signals according to the IEEE 16.11 standard, including IEEE 16.11(a), (b), or (g), or the IEEE 802.11 standard, including IEEE 802.11a, b, g or n. In some other implementations, the antenna 43 transmits and receives RF signals according to the BLUETOOTH standard. In the case of a cellular telephone, the antenna 43 is designed to receive code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1xEV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless network, such as a system utilizing 3G or 4G technology. The transceiver 47 can pre-process the signals received from the antenna 43 so that they may be received by and further manipulated by the processor 21. The transceiver 47 also can process signals received from the processor 21 so that they may be transmitted from the display device 40 via the antenna 43. The processor 21 may be configured to receive time data, e.g., from a time server, via the network interface 27.

In some implementations, the transceiver 47 can be replaced by a receiver. In addition, the network interface 27 can be replaced by an image source, which can store or generate image data to be sent to the processor 21. The processor 21 can control the overall operation of the display device 40. The processor 21 receives data, such as compressed image data from the network interface 27 or an image source, and processes the data into raw image data or into a format that is readily processed into raw image data. The processor 21 can send the processed data to the driver controller 29 or to the frame buffer 28 for storage. Raw data typically refers to the information that identifies the image characteristics at each location within an image. For example, such image characteristics can include color, saturation, and gray-scale level.

The processor 21 can include a microcontroller, CPU, or logic unit to control operation of the display device 40. The conditioning hardware 52 may include amplifiers and filters for transmitting signals to the speaker 45, and for receiving signals from the microphone 46. The conditioning hardware 52 may be discrete components within the display device 40, or may be incorporated within the processor 21 or other components.

The driver controller 29 can take the raw image data generated by the processor 21 either directly from the processor 21 or from the frame buffer 28 and can re-format the raw image data appropriately for high speed transmission to the array driver 22. In some implementations, the driver controller 29 can re-format the raw image data into a data flow having a raster-like format, such that it has a time order suitable for scanning across the display array 30. Then the driver controller 29 sends the formatted information to the array driver 22. Although a driver controller 29, such as an LCD controller, is often associated with the system processor 21 as a stand-alone integrated circuit (IC), such controllers may be implemented in many ways. For example, controllers may be embedded in the processor 21 as hardware, embedded in the processor 21 as software, or fully integrated in hardware with the array driver 22.

The array driver 22 can receive the formatted information from the driver controller 29 and can re-format the video data into a parallel set of waveforms that are applied many times per second to the hundreds, and sometimes thousands (or more), of leads coming from the display's x-y matrix of pixels.

In some implementations, the driver controller 29, the array driver 22, and the display array 30 are appropriate for any of the types of displays described herein. For example, the driver controller 29 can be a conventional display controller or a bi-stable display controller (e.g., an IMOD controller). Additionally, the array driver 22 can be a conventional driver or a bi-stable display driver (e.g., an IMOD display driver). Moreover, the display array 30 can be a conventional display array or a bi-stable display array (e.g., a display including an array of IMODs). In some implementations, the driver controller 29 can be integrated with the array driver 22. Such an implementation is common in highly integrated systems such as cellular phones, watches and other small-area displays.

In some implementations, the input device 48 can be configured to allow, e.g., a user to control the operation of the display device 40. The input device 48 can include a keypad, such as a QWERTY keyboard or a telephone keypad, a button, a switch, a rocker, a touch-sensitive screen, or a pressure- or heat-sensitive membrane. The microphone 46 can be configured as an input device for the display device 40. In some implementations, voice commands through the microphone 46 can be used for controlling operations of the display device 40.

The power supply 50 can include a variety of energy storage devices as are well known in the art. For example, the power supply 50 can be a rechargeable battery, such as a nickel-cadmium battery or a lithium-ion battery. The power supply 50 also can be a renewable energy source, a capacitor, or a solar cell, including a plastic solar cell or solar-cell paint. The power supply 50 also can be configured to receive power from a wall outlet.

In some implementations, control programmability resides in the driver controller 29 which can be located in several places in the electronic display system. In some other implementations, control programmability resides in the array driver 22. The above-described optimization may be implemented in any number of hardware and/or software components and in various configurations.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. For example, although various implementations are described primarily in terms of reflective displays having red, blue and green subpixels, many implementations described herein could be used in reflective displays having other colors of subpixels, e.g., having violet, yellow-orange and yellow-green subpixels. Moreover, many implementations described herein could be used in reflective displays having more colors of subpixels, e.g., having subpixels corresponding to 4, 5 or more colors. Some such implementations may include subpixels corresponding to red, blue, green and yellow. Alternative implementations may include subpixels corresponding to red, blue, green, yellow and cyan. Thus, the disclosure is not intended to be limited to the implementations shown herein, but is to be accorded the widest scope consistent with the claims, the principles and the novel features disclosed herein.

The word “exemplary” is used exclusively herein to mean “serving as an example, instance, or illustration.” Any implementation described herein as “exemplary” is not necessarily to be construed as preferred or advantageous over other implementations. Additionally, a person having ordinary skill in the art will readily appreciate, the terms “upper,” “lower,” “row” and “column” are sometimes used for ease of describing the figures, and indicate relative positions corresponding to the orientation of the figure on a properly oriented page, and may not reflect the proper orientation of the IMOD (or any other device) as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. A reflective display, comprising:
a front light;
a plurality of first reflective sub-pixels corresponding to a first color;
a plurality of second reflective sub-pixels corresponding to a second color;
a plurality of third reflective sub-pixels corresponding to a third color; and
a control system configured to:
write a most significant bit (MSB) of first data corresponding to the first color to at least some of the first reflective sub-pixels;
write a least significant bit (LSB) of the first data to at least some of the third reflective sub-pixels; and
control the front light to flash the first color on the reflective display after the first data have been written to the first and third reflective sub-pixels.

2. The reflective display of claim 1, wherein the control system is further configured to write a next bit of the first data to at least some of the second reflective sub-pixels.

3. The reflective display of claim 1, wherein the control system is further configured to write a least significant bit (LSB) of the first data to at least some of the second reflective sub-pixels.

4. The reflective display of claim 1, wherein the control system is further configured to:
write an MSB of second data corresponding to the second color to at least some of the second reflective sub-pixels;
write an LSB of the second data to at least some of the third reflective sub-pixels; and
control the front light to flash the second color on the reflective display after the second data have been written to the second and third reflective sub-pixels.

5. The reflective display of claim 4, wherein the control system is further configured to write a next bit of the second data to at least some of the first reflective sub-pixels.

6. The reflective display of claim 4, wherein the control system is further configured to write an LSB of the second data to at least some of the first reflective sub-pixels.

7. The reflective display of claim 2, wherein the control system is further configured to:
write an MSB of third data corresponding to the third color to at least some of the third reflective sub-pixels;
write an LSB of the third data to at least some of the first reflective sub-pixels; and
control the front light to flash the third color on the reflective display after the third data have been written to the first and third reflective sub-pixels.

8. The reflective display of claim 7, wherein the control system is further configured to write a next bit of the third data to at least some of the second reflective sub-pixels.

9. The reflective display of claim 7, wherein the control system is further configured to write an LSB of the third data to at least some of the second reflective sub-pixels.

10. The reflective display of claim 1, wherein the control system includes at least one of a general purpose single-chip or multi-chip processor, a digital signal processor (DSP), an application specific integrated circuit (ASIC), a field programmable gate array (FPGA) or other programmable logic device, discrete gate or transistor logic, or discrete hardware components.

11. The reflective display of claim 1, wherein the control system is further configured to assign bit values according to grayscale levels that correspond with values of the MSB, the next bit and the LSB.

12. The reflective display of claim 11, wherein the control system is further configured to receive grayscale level data and to determine the bit values according to the grayscale level data.

13. The reflective display of claim 12, wherein the control system is further configured to determine the bit values by referencing a data structure that has the grayscale levels and corresponding values of the MSB, the next bit and the LSB stored therein.

14. The reflective display of claim 1, wherein:
the first reflective sub-pixels have a first spectral response with a first peak wavelength range corresponding to the first color;
the second reflective sub-pixels have a second spectral response with a second peak wavelength range corresponding to the second color;
the third reflective sub-pixels have a third spectral response with a third peak wavelength range corresponding to the third color; and
the second spectral response overlaps with the first spectral response within the first peak wavelength range and overlaps with the third spectral response within the third peak wavelength range.

15. The reflective display of claim 14, wherein:
the next bit of the first data corresponds with the second spectral response of the second reflective sub-pixels within the first peak wavelength range; and
the next bit of the third data corresponds with the second spectral response of the second reflective sub-pixels within the third peak wavelength range.

16. The reflective display of claim 14, wherein:
the MSB of the first data corresponds with the first spectral response of the first reflective sub-pixels within the first peak wavelength range;
the MSB of the second data corresponds with the second spectral response of the second reflective sub-pixels within the second peak wavelength range; and
the MSB of the third data corresponds with the third spectral response of the third reflective sub-pixels within the third peak wavelength range.

17. The reflective display of claim 14, wherein:
the first spectral response overlaps with the third spectral response within the third peak wavelength range; and
the third spectral response overlaps with the first spectral response within the first peak wavelength range.

18. The reflective display of claim 17, wherein:
the LSB of the first data corresponds with the third spectral response of the third reflective sub-pixels within the first peak wavelength range;
the LSB of the second data corresponds with the third spectral response of the third reflective sub-pixels within the second peak wavelength range; and
the LSB of the third data corresponds with the first spectral response of the first reflective sub-pixels within the third peak wavelength range.

19. The reflective display of claim 1, further comprising:
a memory device, wherein the control system includes a processor that is configured to communicate with the reflective display, the processor being configured to process image data; and
wherein the memory device is configured to communicate with the processor.

20. The reflective display of claim 19, wherein the control system further comprises:
a driver circuit configured to send at least one signal to the display; and
a controller configured to send at least a portion of the image data to the driver circuit.

21. The reflective display of claim 19, further comprising:
an image source module configured to send the image data to the processor, wherein the image source module includes at least one of a receiver, a transceiver or a transmitter.

22. The reflective display of claim 1, further comprising:
an input device configured to receive input data and to communicate the input data to the control system.

23. A method of controlling a reflective display, the method comprising:
writing a most significant bit (MSB) of first data corresponding to a first color to first reflective sub-pixels;
writing a least significant bit (LSB) of the first data to third reflective sub-pixels corresponding to a third color; and
controlling a front light to flash the first color on the reflective display after the first data have been written to the first and third reflective sub-pixels.

24. The method of claim 23, further comprising:
writing a next bit of the first data to second reflective sub-pixels corresponding to a second color.

25. The method of claim 23, further comprising:
writing an LSB of the first data to second reflective sub-pixels corresponding to a second color.

26. The method of claim 23, further comprising:
writing an MSB of second data corresponding to the second color to the second reflective sub-pixels;
writing an LSB of the second data to the third reflective sub-pixels; and
controlling the front light to flash the second color on the reflective display after the second data have been written to the second and third reflective sub-pixels.

27. The method of claim 26, further comprising:
writing a next bit of the second data to the first reflective sub-pixels.

28. The method of claim 26, further comprising:
writing an LSB of the second data to the first reflective sub-pixels.

29. The method of claim 26, further comprising:
writing an MSB of third data corresponding to the third color to the third reflective sub-pixels;
writing an LSB of the third data to the first reflective sub-pixels; and
controlling the front light to flash the third color on the reflective display after the third data have been written to the first and third reflective sub-pixels.

30. The method of claim 29, further comprising:
writing a next bit of the third data to the second reflective sub-pixels.

31. The method of claim 29, further comprising:
writing an LSB of the third data to the second reflective sub-pixels.

32. Apparatus for controlling a reflective display, the apparatus comprising:
means for writing a most significant bit (MSB) of first data corresponding to a first color to first reflective sub-pixels, for writing a next bit of the first data to second reflective sub-pixels corresponding to a second color and for writing a least significant bit (LSB) of the first data to third reflective sub-pixels corresponding to a third color; and
means for controlling a front light to flash the first color on the reflective display after the first data have been written to the first, second and third reflective sub-pixels.

33. The apparatus of claim 32, wherein the writing means is configured for writing an MSB of second data corresponding to the second color to the second reflective sub-pixels, for writing a next bit of the second data to the first reflective sub-pixels and for writing an LSB of the second data to the third reflective sub-pixels; and
wherein the controlling means is configured for controlling the front light to flash the second color on the reflective display after the second data have been written to the first, second and third reflective sub-pixels.

34. The apparatus of claim 33, wherein the writing means is configured for writing an MSB of third data corresponding to the third color to the third reflective sub-pixels, for writing a next bit of the third data to the second reflective sub-pixels and for writing an LSB of the third data to the first reflective sub-pixels; and
wherein the controlling means is configured for controlling the front light to flash the third color on the reflective display after the third data have been written to the first, second and third reflective sub-pixels.

35. A non-transitory storage medium having software encoded thereon, the software including instructions for controlling a reflective display to perform a method comprising:
writing a most significant bit (MSB) of first data corresponding to a first color to first reflective sub-pixels corresponding to the first color;
writing a least significant bit (LSB) of the first data to second reflective sub-pixels corresponding to a second color;
writing the LSB of the first data to third reflective sub-pixels corresponding to a third color; and
controlling a front light to flash the first color on the reflective display after the first data have been written to the first, second and third reflective sub-pixels.

36. The non-transitory storage medium of claim 35, wherein the method further comprises:
writing an MSB of second data corresponding to the second color to the second reflective sub-pixels;
writing an LSB of the second data to the first reflective sub-pixels;
writing the LSB of the second data to the third reflective sub-pixels; and
controlling the front light to flash the second color on the reflective display after the second data have been written to the first, second and third reflective sub-pixels.

37. The non-transitory storage medium of claim 36, wherein the method further comprises:
writing an MSB of third data corresponding to the third color to the third reflective sub-pixels;
writing an LSB of the third data to the second reflective sub-pixels;
writing the LSB of the third data to the first reflective sub-pixels; and
controlling the front light to flash the third color on the reflective display after the third data have been written to the first, second and third reflective sub-pixels.
